(19) United States
(12) Patent Application Publication
(10) Pub. No.: US 2012/0120328 A1
(43) Pub. Date: May 17, 2012

(54) Transflective Liquid Crystal Displays Using Transverse Electric Field Effect

(76) Inventor: Ruibo Lu, San Bruno, CA (US)

(21) Appl. No.: 13/044,064

(22) Filed: Mar. 9, 2011

Related U.S. Application Data
(60) Provisional application No. 61/413,273, filed on Nov. 12, 2010.

(51) Int. Cl. G02F 1/1335; H01J 9/20; G02F 1/13357; G02F 1/13

(52) U.S. Cl. 349/1; 349/114; 445/24; 349/62

(57) ABSTRACT

Techniques are provided for transflective LCDs using homogeneously aligned liquid crystal materials which optical birefringence is electrically controllable. An unpaired retarder may be configured to compensate, in transmissive parts, for the effect of reflection in reflective parts. A light recycling/redirecting film may be added between a BLU and a nearby polarization layer to recycle backlight from a reflective part of an LCD unit structure into a transmissive part of the same structure to increase the optical output efficiency of the BLU. Electrodes for the transmissive part and the reflective part may be separately driven in various operating modes. Benefits include high transmittance, high reflectance, wide view angles, improved optical recycling efficiency, and low manufacturing costs.

### BENEFIT CLAIM

This application claims the benefit, under 35 U.S.C. 119(e), of prior provisional application 61/413,273 (attorney docket no. 60203-0066), filed Nov. 12, 2010, the entire contents of which are hereby incorporated by reference for all purposes as if fully set forth herein.

### CROSS REFERENCE TO RELATED APPLICATIONS

This application is related to U.S. patent application Ser. No. 12/503,793, filed Jul. 15, 2009; U.S. patent application Ser. No. 12/560,217, filed Sep. 15, 2009, the entire contents of which are hereby incorporated by reference for all purposes as if fully disclosed herein.

### TECHNICAL FIELD

The present disclosure relates to Liquid Crystal Displays (LCDs).

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

A transflective LCD, which comprises an array of pixels or sub-pixels each having a reflective part and a transmissive part, may be used in cell phones, electronic books, and personal computers in part because readability of the transflective LCD typically is not limited by ambient lighting conditions. The reflective part and the transmissive part in a pixel or sub-pixel of the transflective LCD may be simultaneously used to express a single pixel or sub-pixel value.

In-plane switching (IPS) or fringe field switching (FFS) modes have been used in transflective LCD displays, for example, for mobile devices. These LCD transflective displays typically have small reflective parts in relation to transmissive parts. An in-cell retarder that happens to covers the transmissive parts in these LCD displays usually narrows the viewing angle. Hence, these transflective LCD displays without an in-cell retarder or with an in-cell retarder also covering transmissive parts have limited sunlight and outdoors readability.

In some displays, a patterned in-cell retarder may be used with FFS and IPS modes in transflective LCD displays. For example, the patterned in-cell retarder may be designed to cover reflective parts only. However, a manufacturing process to place the patterned in-cell retarder over reflective parts only is complex and costly.

### BRIEF DESCRIPTION OF THE DRAWINGS

Various embodiments of the present invention will herein after be described in conjunction with the appended drawings, provided to illustrate and not to limit the present invention, wherein like designations denote like elements, and in which:

FIG. 1 illustrates a schematic cross-sectional view of an example transflective Electrically-Controlled-Birefringence (ECB) LCD unit structure.

FIG. 2A illustrates a schematic cross-sectional view of an example transflective Fringe-Field-Switching (FFS) LCD unit structure.

FIG. 2B illustrates a stripe-shape electrode configuration for an FFS LCD unit structure.

FIG. 2C illustrates a zigzag-shape electrode configuration for an FFS LCD unit structure.

FIG. 3A illustrates a schematic cross-sectional view of an example transflective in-plane switching (IPS) LCD unit structure.

FIG. 3B illustrates a stripe-shape electrode configuration for an IPS LCD unit structure.

FIG. 3C illustrates a zigzag-shape electrode configuration for an IPS LCD unit structure.

FIG. 4A and FIG. 4B shows example view angle measurements of an FFS LCD unit structure with a stripe-shaped electrode configuration.

FIG. 4C and FIG. 4D shows example view angle measurements of an FFS LCD unit structure with a zigzag-shaped electrode configuration.

FIG. 5A and FIG. 5B shows example view angle measurements of an IPS LCD unit structure with a stripe-shaped electrode configuration.

FIG. 5C and FIG. 5D shows example view angle measurements of an IPS LCD unit structure with a zigzag-shaped electrode configuration.

The drawings are not rendered to scale.

### DETAILED DESCRIPTION

Techniques for transflective LCDs using transverse electric field effect are described. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

### 1. General Overview

In embodiments, transflective LCDs use backlight, or additionally ambient light, to show color images in a transmissive or transflective operating mode, and use only ambient light to show black-and-white images in a reflective operating mode. In embodiments, the transflective LCDs has wide view angles. In embodiments, the transflective LCDs have fewer in-cell retardation films and incur lower manufacturing costs than otherwise. In embodiments, the transflective LCDs exhibit good ambient light readability and low power consumption.

In embodiments, a unit structure of a transflective LCD comprises a homogenously aligned liquid crystal layer in both a reflective part and a transmissive part. As used herein, “a homogenously aligned liquid crystal layer” means that in a voltage-off state, the liquid crystal layer remains homogeneously aligned to a same direction within each of the transmissive part and the reflective part; however, the liquid crystal layer portion in the transmissive part may or may not be aligned with the liquid crystal layer portion in the reflective part. In embodiments, the transflective LCD unit structure shows high transmittance in the transmissive part and high reflectance in the reflective part. In embodiments, backlight in the reflective part of a transflective LCD unit structure is re-circulated into the transmissive part.

In embodiments, a transflective liquid crystal display comprises a plurality of unit structures, each unit structure comprising a reflective part and a transmissive part. The reflective part comprises first portions of a first polarizing layer, a second polarizing layer, a first substrate layer, a second substrate layer, and a first half-wave retardation film. The second substrate layer is opposite to the first substrate layer. The reflective part may further comprise a first common electrode portion; a reflective electrode an over-coating layer adjacent to one of the first substrate layer and the second substrate layer; and a reflective layer adjacent to the first substrate layer.

In embodiments, the first substrate layer and the second substrate layer are between the first polarizing layer and the second polarizing layer.

In embodiments, the reflective part may further comprise a first liquid crystal layer portion of a liquid crystal layer between the first substrate layer and the second substrate layer. The liquid crystal molecules in the first liquid crystal layer portion may be substantially homogeneously aligned along a direction in a voltage-off state.

In embodiments, the transmissive part comprises second portions of the first polarizing layer, the second polarizing layer, the first substrate layer, the second substrate layer, and the first half-wave retardation film. The transmissive part may further comprise a second liquid crystal layer portion of the liquid crystal layer between the first substrate layer and the second substrate layer; a second common electrode portion; a transmissive electrode; a second half-wave retardation film; and a third half-wave retardation film.

In embodiments, a cell gap of the first liquid crystal layer portion is different from a cell gap of the second liquid crystal layer portion.

In embodiments, liquid crystal molecules in the second liquid crystal layer portion may be substantially homogeneously aligned along a second direction in the voltage-off state.

In embodiments, the unit structure further comprises at least one color filter that covers at least an area of the transmissive part, wherein the unit structure is configured to express a color value associated with a color of the at least one color filter.

In embodiments, the unit structure is a part of a composite pixel, which comprises another unit structure that is configured to express a different color value other than the color value expressed by the unit structure.

In embodiments, a normal direction of a surface of the first substrate layer is aligned in parallel with one or more of the first direction and the second direction.

In embodiments, the unit structure further comprises one or more orientation films and wherein one or more of the first direction and the second direction are along a rubbing direction of at least one of the one or more orientation films.

In embodiments, at least one of the first half-wave retardation film, the second half-wave retardation film, or the third half-wave retardation film, is one of a uniaxial retardation film, a biaxial retardation film, or an oblique retardation film.

In embodiments, the liquid crystal layer comprises a liquid crystal material which optical birefringence is electrically controllable.

In embodiments, the first half-wave retardation film and the first liquid crystal layer portion may form a wideband quarter-wave plate in the voltage-off state.

In embodiments, the first half-wave retardation film has an azimuth angle of θₕ, wherein the first liquid crystal layer portion has an azimuth angle of θ_{q}. The azimuth angles satisfy one of (1) 60≦4θₕ−2θ_{q}≦120, or (2) −120≦4θₕ−2θ_{q}≦−60.

In embodiments, the first half-wave retardation film and the first liquid crystal layer portion in the voltage-off state may form a first wideband quarter-wave plate in the reflective part. The second liquid crystal layer portion and the second half-wave retardation film and in the voltage-off state may form a second wideband quarter-wave plate in the transmissive part.

In embodiments, the first half-wave retardation film has a first azimuth angle of θₕ, wherein the first liquid crystal layer portion has an azimuth angle of θ_{q}. The second azimuth angle of the second half-wave retardation film may be substantially θₕ (e.g., within a small tolerance: one of +/−0.1, 1, 2, or another small percent). The angles θₕ and θ_{q} satisfy one of (1) 60≦4θₕ−2θ_{q}≦120, or (2) −120≦4θₕ−2θ_{q}≦−60, where numeric values indicate degrees.

In embodiments, the unit structure further comprises a first quarter-wave film, and a second quarter-wave film. The first half-wave retardation film and the first quarter-wave may form a first wideband quarter-wave plate in both the transmissive part and the reflective part, while the second half-wave retardation film and the second quarter-wave may form a second wideband quarter-wave plate in the transmissive part.

In embodiments, the first half-wave retardation film has a first azimuth angle of θₕ. The first quarter-wave film has a second azimuth angle of θ_{q}. A third azimuth angle of the second half-wave retardation film is substantially θₕ. A fourth azimuth angle of the second quarter-wave film is substantially θₕ. In embodiments, θₕ and θ_{q} may satisfy one of (1) 60≦4θₕ−2θ_{q}≦120, or (2) −120≦4θₕ−2θ_{q}≦−60

In embodiments, the unit structure may comprise a switching element that is configured to control whether the reflective electrode is electrically connected to the transmissive electrode.

In embodiments, the common electrode is located on a first side of the liquid crystal layer and the transmissive electrode and the reflective electrode are located on a second opposing side of the liquid crystal layer.

In embodiments, the common electrode, the transmissive electrode, and the reflective electrode are located on a same side of the liquid crystal layer. The unit structure further may comprise a passivation layer. The common electrode may be located on a first side of the passivation layer, while the transmissive electrode and the reflective electrode may be located on a second opposing side of the passivation layer.

In embodiments, at least one of the common electrode, the transmissive electrode and the reflective electrode may be formed by a non-perforated planar layer of a conductive material.

In embodiments, at least one of the common electrode, the transmissive electrode, and the reflective electrode may be formed by a plurality of discrete conductive components, and wherein two neighboring discrete conductive components is spatially separated by a non-conductive gap.

In embodiments, the unit structure may further comprise a light recycling film between the first substrate layer and a backlight unit that redirects backlight from the reflective part to the transmissive part. The light recycling film may be configured to turn incident light of any polarized state into redirected light with a particular polarization state.

In some embodiments, a transflective LCD as described herein forms a part of a computer, including but not limited to a laptop computer, netbook computer, cellular radiotelephone, electronic book reader, point of sale terminal, desktop computer, computer workstation, computer kiosk, or computer coupled to or integrated into a gasoline pump, and various other kinds of terminals and display units.

In some embodiments, a method comprises providing a transflective LCD as described, and a backlight source to the transflective LCD.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. Structural Overview

In some embodiments, a transflective LCD may comprise homogeneously aligned liquid crystal materials to be driven by a transverse electric field. Electrically controlled birefringence, in-plane switching, fringe field switching, etc., may be used to generate the transverse electric field. In some embodiments, the common electrode and the pixel electrode that are used to generate the transverse electric field may be deposited on the same surface or substrate. In some other embodiments, the common electrode and the pixel electrode may be deposited on different surfaces or substrates. As used herein, a pixel electrode may refer to a transmissive electrode in a transmissive part, or to a reflective electrode in a reflective part.

For the purpose of illustration, a viewer located at the top looks in a downward direction at an LCD display.

In some embodiments, at a voltage-off state, a wideband circular polarizer may be formed in the reflective part of a LCD unit structure, comprising, for example, (a) a top linear polarizer, (b) a top half-wave (HW) retarder (or retardation film), and (c) a liquid crystal (LC) layer constituting a quarter-wave (QW) plate. The ambient light entering the top linear polarizer becomes linearly polarized. After passing through the top HW retarder, which may be a biaxial one for wide view angle, the polarization angle of the linearly polarized light is shifted an azimuthal angle of θₕ corresponding to the optical axis of the top HW retarder, where θₕ is the azimuthal angle between the absorption axis of top linear polarizer and the optical axis of the top HW retarder. In some embodiments, the shifted polarization angle of the light from the top HW retarder forms a 45° angle relative to the azimuthal angle of the QW LC layer.

In these embodiments, the linearly polarized light becomes circularly polarized (CP) when entering the QW LC layer, for example, with a right-handed rotational direction. In some possible embodiments, one of the following expressions may be used to obtain a wideband circular polarizer.

60≦4θh−2θq≦120 expression (1)

−120≦4θh−2θq≦−60 expression (2)

where θₕ is the azimuthal angle of the top HW retarder, and θ_{q} is the azimuthal angle of the LC layer as a QW plate in the reflective part.

When the right-handed circularly polarized light passing through the QW LC layer incidents on the bumpy reflector, the light is reflected back with a left-handedness rotational direction. After passing through the QW LC layer and the top HW retarder again, the right-handed circularly polarized light that incident on the bumpy reflector is degenerated into a linearly polarizer light with a polarization direction rotated 90° relative to its previous linear polarization state. Since its linear polarization direction is reversed 90°, the light may be blocked by the top linear polarizer, thereby resulting in dark black state in the reflective part at the voltage-off state.

At a voltage-on state, for example, when an applied voltage between the common electrode and the pixel electrode is higher than a threshold voltage, the transverse electric field may be generated between the common electrode and the pixel electrode. The transverse electric field may twist the LC molecules between electrode gaps and electrodes. The phase retardation of the LC layer may be changed and may no longer work as a QW plate. This breaks the circularly polarized configuration in the voltage-off state. As a result, the ambient light may pass through the top polarizer after being reflected in the reflective part, thereby resulting in a bright state at the voltage-on state.

In some embodiments, the transmissive part may comprise extra optical components in addition to the top linear polarizer and the top HW retarders as mentioned above. For example, the transmissive part may further comprise a bottom linear polarizer and two bottom HW retarders, in combination with an LC layer with a cell gap which may or may not be different from the cell gap of the LC layer in the receiver part.

In some embodiments, the extra optical components in the transmissive part and/or the different cell gap LC layer may be configured to compensate for the optical components in the R-part, and hence to create a crossed configuration that generates a black state at the voltage-off state.

In some embodiments, the bottom linear polarizer may be arranged with its absorption axis at 90° relative to that of the top linear polarizer; a first HW retarder of the two bottom HW retarders may be arranged with its slow axis at 90° relative to that of the top HW retarder; and a second HW retarder of the two bottom HW retarders may be arranged at 90° relative to the alignment direction of the LC layer in the transmissive part. In these embodiments, a combination of the bottom linear polarizer, two bottom HW retarders and bottom half of the LC layer may form a crossed part of a combination of the top linear polarizer, top HW retarder and top half of LC layer. This optical configuration may be used to support high contrast ratio in the transmissive part when the transflective LCD operates in a transmissive mode. In some possible embodiments, zero, one or more of the HW retarders herein may be biaxial to support wide view angle in the transmissive mode. In some possible embodiments, zero, one or more of the HW retarders herein may be uniaxial, or of another different axial property than biaxial.

In some possible embodiments, backlight from backlight unit (BLU) first passes through the bottom linear polarizer, and becomes linearly polarized. After passing through the first HW retarder, the polarization angle of the linearly polarized backlight is shifted an azimuthal angle of θ₁ corresponding to the first HW retarder. Then, after passing through the second HW retarder, the polarization angle of the linearly polarized backlight is shifted an azimuthal angle of θ₂ corresponding to the second HW retarder. In some possible embodiments, the linearly polarized backlight after passing through the second HW retarder may have an azimuthal angle of 45° relative to the alignment direction of the LC layer in the transmissive part. After passing through the bottom half part of the LC layer, the backlight becomes circularly polarized. Since the polarization angle of the backlight exiting the bottom linear polarizer is 90° crossed with that of the top linear polarizer. The backlight exiting from the bottom part of the transmissive part (e.g., exiting from the bottom half of the LC layer) may be circularly polarized with a left-handedness rotational direction. This is opposite to the right-handedness rotational direction produced by the top part of the transmissive part comprising the top linear polarizer, top HW retarder, and top half of the LC layer in the transmissive part, thereby resulting in a black state in the voltage-off state.

In some embodiments, when an applied voltage between the common electrode and the pixel electrode is higher than the threshold voltage, a transverse electric field may appear and twist the LC molecules between the electrode gaps and electrodes. The phase retardation of the top and bottom parts of the LC layer may be changed and may no longer work as two QW plates. This may break the CP configuration in the voltage-off state. The backlight may exit from the top linear polarizer towards the viewer, resulting in a bright state in the voltage-on state for the transmissive part in the transmissive mode.

As used in this disclosure, “a transflective LCD unit structure in a voltage-off state” means that the unit structure is in a state in which (1) a voltage is not applied to a liquid crystal layer in the unit structure or (2) even if applied, is below a threshold value to cause a deviation from the state of the liquid crystal layer when the voltage is not applied. The term “transflective LCD unit structure” may refer to a pixel or a sub-pixel in the transflective LCD. As used in this disclosure, “a liquid crystal cell gap” refers to the thickness of the liquid crystal layer in either the transmissive part or the reflective part. As used herein, black state and bright states refer to optical states, while voltage-on and voltage-on states refer to electric states.

Different optical configurations may be used in various embodiments of the present invention. For example, other polarizers other than linear polarizers and/or other retarders other than HW ones may be used. In various embodiments, techniques herein may be implemented to avoid or reduce the use of in-cell retarders in normally black or normally white transflective LCD displays.

In some embodiments, since the backlight that incident on the bottom part of the reflective part is linearly polarized, the backlight may be reflected from the bumpy reflector and/or opaque metals and/or thin-film transistors (TFTs) into the transmissive part. A light recycling film or a light redirecting film may be additionally and/or optionally placed between the BLU and the bottom polarizer to recycle the reflected backlight from the reflective part into the transmissive part for a high optical output of BLU source. The separate and combined driving of the respective transmissive and reflective parts may also be used to support various operating modes of the transflective LCD, thereby realizing a display that may be normally black or normally white to work with high transmittance/reflectance and improved optical recycling efficiency. Under techniques as described herein, in-cell retarders is not required as retarders herein may be coated or deposited to cover both the transmissive part and the reflective part, thereby significantly simplifying the manufacturing process. As a result, displays implementing techniques herein may be produced with high efficiency, excellent readability, low power consumption and low manufacturing costs.

2.1 Electrically Controlled Birefringence (ECB)

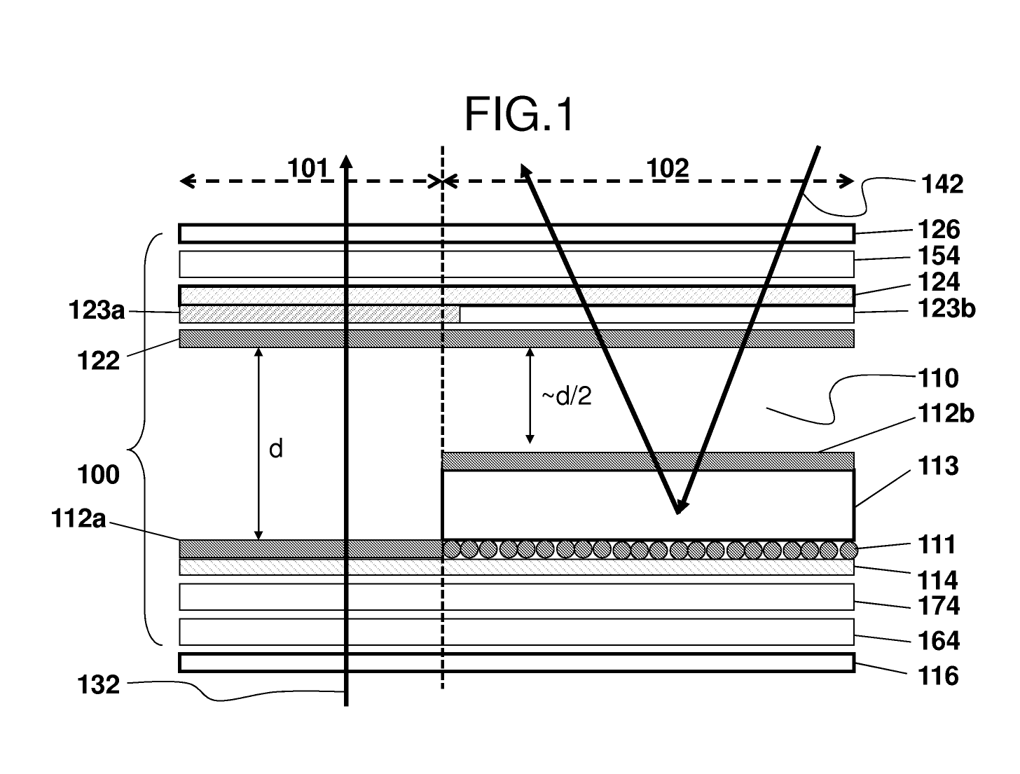

FIG. 1 illustrates a schematic cross-sectional view of an example transflective LCD unit structure 100. As illustrated, the LCD unit structure 100 comprises a transmissive part 101 and a reflective part 102 along the horizontal direction of FIG. 1. The transmissive part 101 and the reflective part 102 have different layered structures along the vertical direction of FIG. 1.

In some embodiments, the LCD unit structure 100 comprises a layer 110 of homogeneously aligned liquid crystal material extending over both the transmissive part 101 and the reflective part 102. When both the transmissive part 101 and the reflective part 102 comprise structures to operate in an ECB configuration as illustrated here, the liquid crystal layer 110 in both the transmissive part 101 and the reflective part 102 may align with a same direction in the voltage-off state. The liquid crystal layer 110 may be filled into a cell space by a capillary effect or a one-drop filling process under the vacuum condition. In some embodiments, the liquid crystal layer 110 is of a positive dielectric anisotropy type with Δ∈>0. In some embodiments, the liquid crystal layer 110 is of a negative dielectric anisotropy type with Δ∈<0.

Color filters 123a may be deposited on or near a surface of a top substrate layer 124. The color filters may cover both the transmissive part 101 and some, or all, area of the reflective part 102, or only cover the transmissive part 101, as viewed by a viewer from the top direction of FIG. 1. In some possible embodiments, there may be red, green and blue (RGB) color filters 123a deposited on or near a surface of the top substrate layer 124, e.g., the inner surface of the top substrate layer 124 facing the liquid crystal layer 110 in the transmissive part 101. In areas that are not covered by the color filters 123a, an over-coating layer 123b may be configured. This over-coating layer 123b may be a passivation layer comprising an organic material such as a-Si:C:O and a-Si:O:F, or an inorganic material such as silicon nitride (SiNx) and silicon oxide (SiO2), prepared by plasma enhanced chemical vapor deposition or other similar sputtering methods.

A top retarder 154, which is equivalent to a half-wave (HW) plate, may be inserted between the LC layer 110 and the layer comprising the color filters 123a and/or the over-coating layer 123b. An over-coating layer 113 may be formed in a partially etched region by a photolithographic etching process in the reflective part 102. In various embodiments, the over-coating layer 113 may comprise acrylic resin, polyamide, or novolac epoxy resin.

The transmissive part 101 may have a different liquid crystal cell gap than that of the reflective part 102. In some embodiments, in part due to the over-coating layer 113, the liquid crystal cell gap in the reflective part 102 may be approximately one half of the liquid crystal cell gap in the transmissive part 101.

An ITO layer 122 may be located between the top substrate layer 124 and the liquid crystal layer 110 as a common electrode. In some embodiments, this ITO layer 122 covers the whole area of the LCD unit structure.

In some embodiments, a metallic reflective layer 111 such as aluminum (Al) or silver (Ag) may be inserted adjacent to the inner face of the bottom substrate layer 114. In some embodiments, this metallic reflective layer 111 may be a bumpy metal layer.

An ITO layer 112a may be deposited on top of the bottom substrate layer 114 in the transmissive part 101, while an ITO layer 112b may be deposited on top of the over-coating layer 113.

A bottom linear polarization layer 116 and a top linear polarization layer 126 with orthogonal polarization axes may be attached on outer surfaces of the bottom substrate layer 114 and top substrate layer 124 respectively.

The ITO layers 112a and 112b may be used as a transmissive electrode for the transmissive part 101 and a reflective electrode for the reflective part 102, respectively. A switching element may be configured in the unit structure 100 to control whether the reflective electrode is connected or disconnected with the transmissive electrode in the transmissive part 101. For example, in some operating modes of a transflective LCD display comprising the LCD unit structure 100, the switching element, working in conjunction with display mode control logic, may cause the reflective electrode to be connected to the transmissive electrode; hence, the reflective and transmissive electrodes may be driven by a same signal to cause the transmissive part 101 and the reflective part 102 to simultaneously express a same pixel or sub-pixel value. In some other operating modes, on the other hand, the switching element may cause the reflective electrode to be disconnected from the transmissive electrode; hence, the reflective and transmissive electrodes may be driven by separate signals to cause the transmissive part 101 and the reflective part 102 to independently express different pixel or sub-pixel values. For example, in a transmissive operating mode, the transmissive part 101 may be set according to a pixel or sub-pixel value based on image data, while the reflective part 102 may be set in a dark black state. In a reflective operating mode, on the other hand, the reflective part 102 may be set according to a pixel or sub-pixel value based on image data, while the transmissive part 101 may be set in a dark black state.

The switching element may be implemented by one or more TFTs hidden beneath the metallic reflective layer 111 in the reflective part 102 to improve the aperture ratio of the transflective LCD.

In some embodiments, in the voltage-off state, the homogeneously aligned liquid crystal layer 110 may be aligned in a direction such that the liquid crystal layer 110 in the transmissive part 101 is substantially a half-wave plate, while the liquid crystal layer 110 in the reflective part 102 is substantially a quarter-wave plate. In different embodiments, liquid crystal materials with different electrically controllable birefringence properties may be used in the liquid crystal layer 110. In some embodiments, rubbed polyimide layers, not shown in FIG. 1, may be formed near a surface of the liquid crystal layer 110 to induce the liquid crystal layer 110 near the rubbed polyimide layers to be homogeneously aligned along a rubbing direction in parallel with the planar surfaces of the substrate layers 114 and 124.

In some embodiments, in the reflective part 116, the top retarder 154 has an azimuth angle of, for example, θₕ. In the voltage-off state, the liquid crystal layer 110 is a quarter-wave plate with an azimuth angle of, for example, θ_{q}. In some embodiments, the top retarder 154 and the liquid crystal layer 110 may form a wideband quarter-wave plate. Since the optical path of the ambient light 142 crosses the top retarder 154 and the liquid crystal layer 110 twice, the optical configuration of the reflective part 102 effectively comprises two broadband quarter-wave with the same azimuth angles θₕ and θ_{q}. Depending on a choice of an optimized central wavelength in the visible range from 380 nm to 780 nm, a retardation value of the broadband quarter-wave plates may be configured with a value between 160 nm and 400 nm. Further, in some embodiments, to realize a pair of achromatic broadband quarter-wave plates in the reflective part, the azimuth angles θₕ and θ_{q} may be configured to satisfy one of the two expressions (1) and (2) as described above.

In the transmissive part 101, in the voltage-on state, an electrically controlled birefringence effect exists between the common electrode and the transmissive electrode, which is the ITO layer 112a, to twist liquid crystal molecules above the transmissive electrode. In some embodiments, the electrically controlled birefringence effect causes the whole or a part of backlight to pass through the top polarization layer 126 towards the viewer, resulting in a bright state.

When the reflective part 102 is in the voltage-on state, an electrically controlled birefringence effect exists between the common electrode and the reflective electrode, which is the ITO layer 112b, to twist liquid crystal molecules above the reflective electrode to cause the liquid crystal layer 110 in the reflective part 101 no longer to be a quarter-wave plate. In some embodiments, the ambient light 142, which is blocked in the voltage-off state, may be reflected off from the metallic reflective layer 111 to show a bright state in the reflective part 102.

The voltage-on state of the transmissive part 101 and the voltage-on state of the reflective part 102 may be independently set. For example, when the switching element causes the reflective electrode to connect to the transmissive electrode, both the transmissive part 101 and the reflective part 102 may be set to a correlated brightness state based on a same pixel value. When the reflective electrode is disconnected to the transmissive electrode, the transmissive part 101 may be set to a first brightness state while the reflective part 102 may be independently set to a second different brightness state.

In some embodiments, color images may be displayed in combination with the R.G.B. color filters 123a in the transmissive part 101 in the transmissive or transflective operating modes, while black and white monochromic images may be shown in the reflective part 102 in the reflective operating modes.

In some embodiments, on the top surface of the top substrate 124 of FIG. 1, a top polarizer layer may be laminated, comprising a top HW retarder such as 154 of FIG. 1 and a top linear polarizer such as 126 of FIG. 1. In some embodiments, on the bottom surface of the bottom substrate 114 of FIG. 1, a bottom polarizer layer may be attached, comprising a bottom linear polarizer such as 116 of FIG. 1, a first HW retarder 164 of FIG. 1, and a second HW retarder 174 of FIG. 1. In some embodiments, zero, one, two, or more of the top HW retarder, the first HW retarder, and the second HW retarder, may be biaxial. In some embodiments, zero, one, two, or more of the top HW retarder, the first HW retarder, and the second HW retarder, may be uniaxial.

2.2 Fringe Field Switching (FFS)

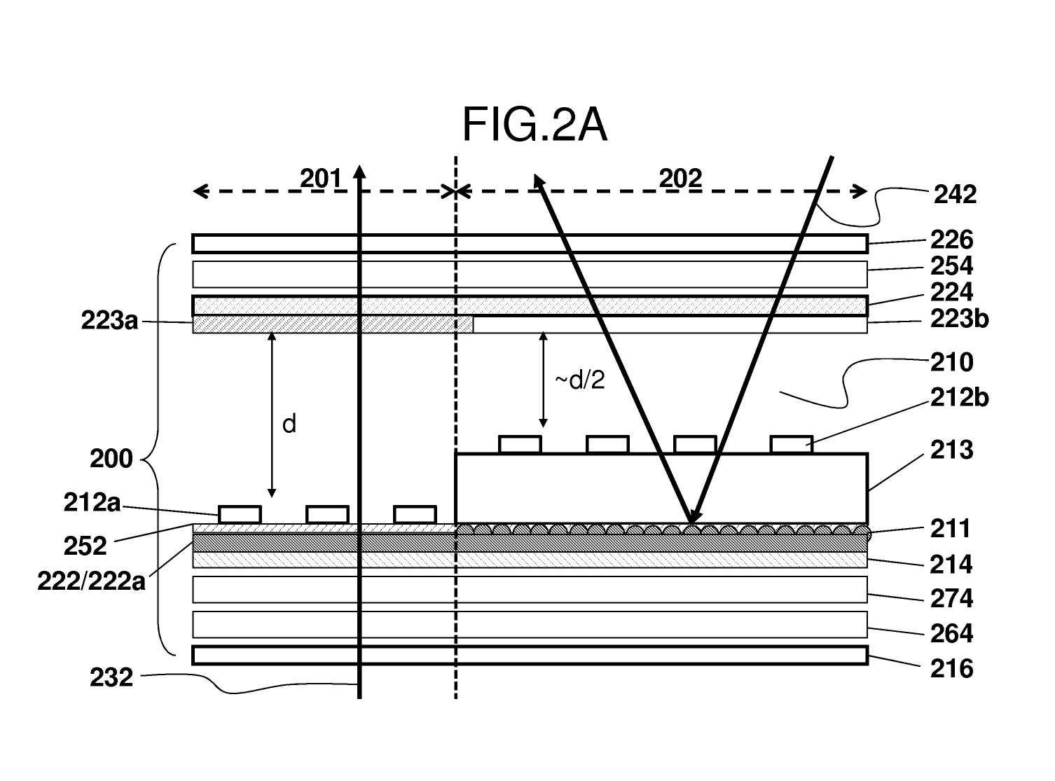

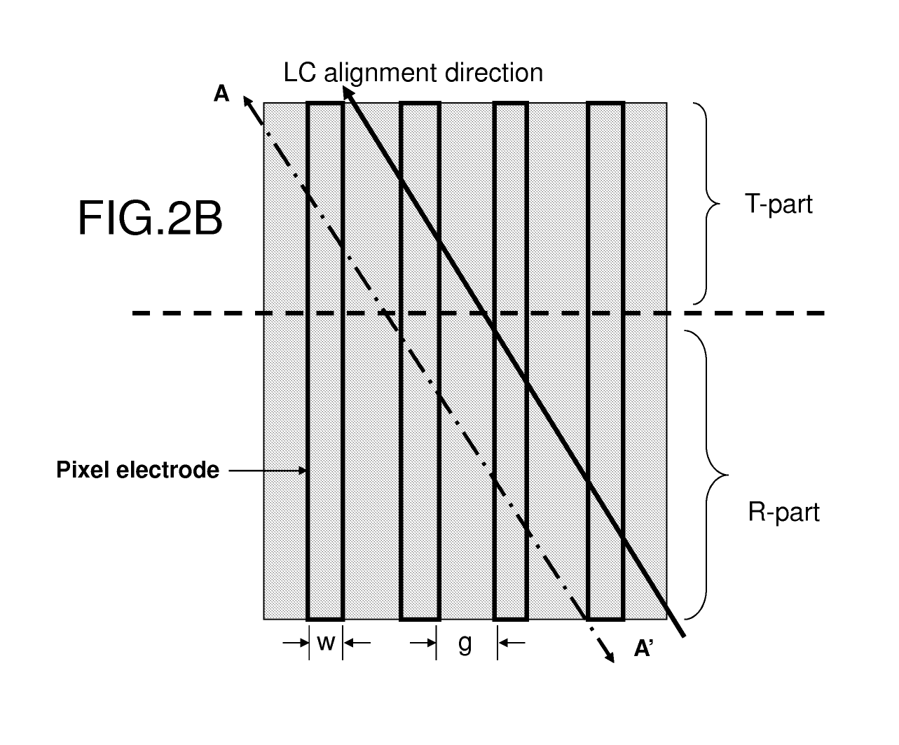

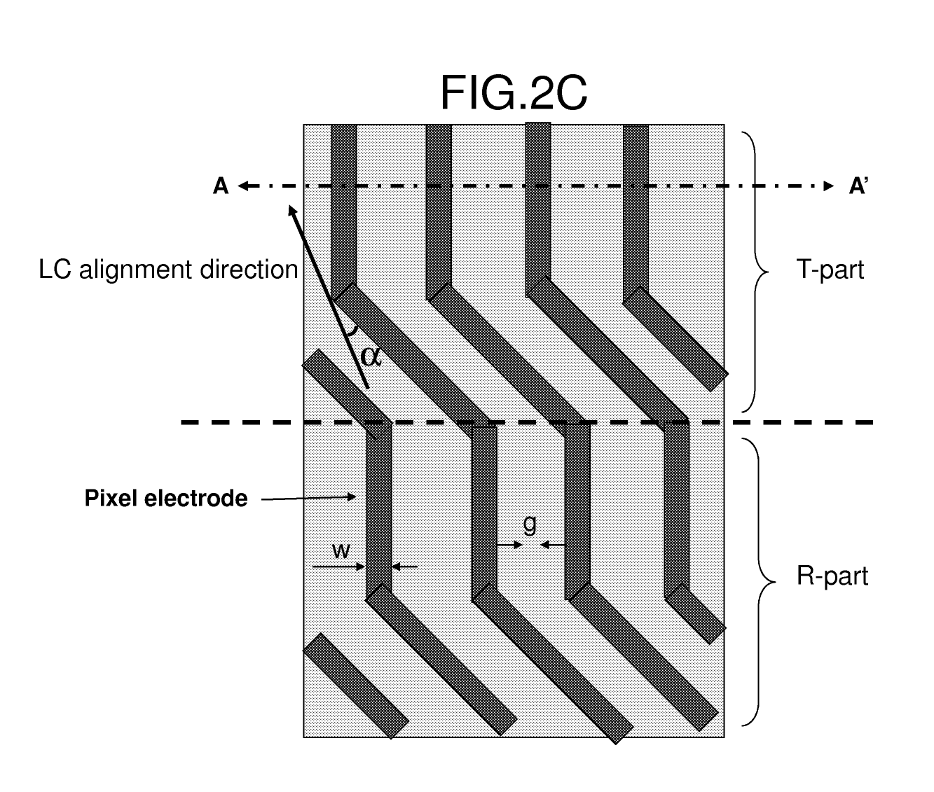

FIG. 2A illustrates a schematic cross-sectional view of an example transflective LCD unit structure 200. As illustrated, the LCD unit structure 200 comprises a transmissive part 201 and a reflective part 202 along the horizontal direction of FIG. 2A. The transmissive part 201 and the reflective part 202 have different layered structures along the vertical direction of FIG. 2A.

In some embodiments, the LCD unit structure 200 comprises a layer 210 of homogeneously aligned liquid crystal material extending over both the transmissive part 201 and the reflective part 202. When both the transmissive part 201 and the reflective part 202 comprise structures to operate in an FFS configuration as illustrated here, the liquid crystal layer 210 in both the transmissive part 201 and the reflective part 202 may align with a same direction in the voltage-off state. The liquid crystal layer 210 may be filled into a cell space by a capillary effect or a one-drop filling process under the vacuum condition. In some embodiments, the liquid crystal layer 210 is of a positive dielectric anisotropy type with Δ∈>0. In some embodiments, the liquid crystal layer 210 is of a negative dielectric anisotropy type with Δ∈<0.

Color filters 223a may be deposited on or near a surface of a top substrate layer 224. The color filters may cover both the transmissive part 201 and some, or all, area of the reflective part 202, or only cover the transmissive part 201, as viewed by a viewer from the top direction of FIG. 2A. In some possible embodiments, there may be red, green and blue (RGB) color filters 223a deposited on or near a surface of the top substrate layer 224, e.g., the inner surface of the top substrate layer 224 facing the liquid crystal layer 210 in the transmissive part 201. In areas that are not covered by the color filters 223a, an over-coating layer 223b may be configured. This over-coating layer 223b may be a passivation layer comprising an organic material such as a-Si:C:O and a-Si:O:F, or an inorganic material such as silicon nitride (SiNx) and silicon oxide (SiO2), prepared by plasma enhanced chemical vapor deposition or other similar sputtering methods.

A top retarder 254, which is equivalent to a half-wave (HW) plate, may be inserted between LC layer 210 and the layer comprising the color filters 223a and/or the over-coating layer 223b. An over-coating layer 213 may be formed in a partially etched region by a photolithographic etching process in the reflective part 202. In various embodiments, the over-coating layer 213 may comprise acrylic resin, polyamide, or novolac epoxy resin.

The transmissive part 201 may have a different liquid crystal cell gap than that of the reflective part 202. In some embodiments, in part due to the over-coating layer 213, the liquid crystal cell gap in the reflective part 202 may be approximately one half of the liquid crystal cell gap in the transmissive part 201.

An ITO layer 222 may be located on or near the inner surface, which faces the liquid crystal layer 210, of a bottom substrate layer 214 as a common electrode 222a. In some embodiments, this ITO layer 222 may cover both the transmissive part 201 and the reflective part 202, or only cover the transmissive part 201. In some embodiments, a metallic reflective layer 211 such as aluminum (Al) or silver (Ag) may be inserted adjacent to the inner face of the bottom substrate layer 214. In the embodiments in which the ITO layer 222 covers both the transmissive part 201 and the reflective part 202, the metallic reflective layer 211 may be deposited on the top surface of the ITO layer 222. In some embodiments, this metallic reflective layer 211 may be a bumpy metal layer. On top of the ITO layer 222 in the transmissive part 201 and the reflective layer 211, an electrically insulating passivation layer 252 may be deposited. In some embodiments, the metallic reflective layer 211 may be connected with the ITO layer 222.

An ITO layer 212a may be deposited on top of the passivation layer 252 in the transmissive part 201, while an ITO layer 212b may be deposited on top of the over-coating layer 213. The ITO layers 212a and 212b may form a perforated pattern comprising a plurality of regular shapes such as stripes or circles, rectangles, etc. A conductive material is deposited substantially only in the regular shapes of patterns. In some embodiments, these regular shapes of patterns in the ITO layers 212a and 212b is electrically insulated or otherwise separated by a gap of a non-conductive material, for example, a dielectric material or simply the liquid crystal material from the layer 210.

A bottom linear polarization layer 216 and a top linear polarization layer 226 with orthogonal polarization axes may be attached on outer surfaces of the bottom substrate layer 214 and top substrate layer 224 respectively.

In some embodiments, the perforated pattern in the ITO layers 212a and 212b may comprise two separate independent perforated sub-patterns. The two separate independent perforated sub-patterns may be used as a transmissive electrode for the transmissive part 201 and a reflective electrode for the reflective part 202, respectively. A switching element may be configured in the unit structure 200 to control whether the reflective electrode is connected or disconnected with the transmissive electrode in the transmissive part 201. For example, in some operating modes of a transflective LCD display comprising the LCD unit structure 200, the switching element, working in conjunction with display mode control logic, may cause the reflective electrode to be connected to the transmissive electrode; hence, the reflective and transmissive electrodes may be driven by a same signal to cause the transmissive part 201 and the reflective part 202 to simultaneously express a same pixel or sub-pixel value. In some other operating modes, on the other hand, the switching element may cause the reflective electrode to be disconnected from the transmissive electrode; hence, the reflective and transmissive electrodes may be driven by separate signals to cause the transmissive part 201 and the reflective part 202 to independently express different pixel or sub-pixel values. For example, in a transmissive operating mode, the transmissive part 201 may be set according to a pixel or sub-pixel value based on image data, while the reflective part 202 may be set in a dark black state. In a reflective operating mode, on the other hand, the reflective part 202 may be set according to a pixel or sub-pixel value based on image data, while the transmissive part 201 may be set in a dark black state.

The switching element may be implemented by one or more TFTs hidden beneath the metallic reflective layer 211 in the reflective part 202 to improve the aperture ratio of the transflective LCD.

In some embodiments, in the voltage-off state, the homogeneously aligned liquid crystal layer 210 may be aligned in a direction such that the liquid crystal layer 210 in the transmissive part 201 is substantially a half-wave plate, while the liquid crystal layer 210 in the reflective part 202 is substantially a quarter-wave plate. In different embodiments, liquid crystal materials with different electrically controllable birefringence properties may be used in the liquid crystal layer 210. In some embodiments, rubbed polyimide layers, not shown in FIG. 2A, may be formed near a surface of the liquid crystal layer 210 to induce the liquid crystal layer 210 near the rubbed polyimide layers to be homogeneously aligned along a rubbing direction in parallel with the planar surfaces of the substrate layers 214 and 224.

In some embodiments, in the reflective part 216, the top retarder 254 has an azimuth angle of, for example, θₕ. In the voltage-off state, the liquid crystal layer 210 is a quarter-wave plate with an azimuth angle of, for example, θ_{q}. In some embodiments, the top retarder 254 and the liquid crystal layer 210 may form a wideband quarter-wave plate. Since the optical path of the ambient light 242 crosses the top retarder 254 and the liquid crystal layer 210 twice, the optical configuration of the reflective part 202 effectively comprises two broadband quarter-wave with the same azimuth angles θₕ and θ_{q}. Depending on a choice of an optimized central wavelength in the visible range from 380 nm to 780 nm, a retardation value of the broadband quarter-wave plates may be configured with a value between 160 nm and 400 nm. Further, in some embodiments, to realize a pair of achromatic broadband quarter-wave plates in the reflective part, the azimuth angles θₕ and θ_{q} may be configured to satisfy one of the two expressions (1) and (2) as described above.

In the transmissive part 201, in the voltage-on state, a fringe field switching effect exists between the common electrode and the transmissive electrode to twist liquid crystal molecules above the transmissive electrode. In some embodiments, the fringe field switching effect causes the whole or a part of backlight to pass through the top polarization layer 226 towards the viewer, resulting in a bright state.

When the reflective part 202 is in the voltage-on state, a fringe field switching effect exists between the common electrode and the reflective electrode, which is the ITO layer 212b, to twist liquid crystal molecules above the reflective electrode to cause the liquid crystal layer 210 in the reflective part 201 no longer to be a quarter-wave plate. In some embodiments, the ambient light 242, which is blocked in the voltage-off state, may be reflected off from the metallic reflective layer 211 to show a bright state in the reflective part 202.

The voltage-on state of the transmissive part 201 and the voltage-on state of the reflective part 202 may be independently set. For example, when the switching element causes the reflective electrode to connect to the transmissive electrode, both the transmissive part 201 and the reflective part 202 may be set to a correlated brightness state based on a same pixel value. When the reflective electrode is disconnected to the transmissive electrode, the transmissive part 201 may be set to a first brightness state while the reflective part 202 may be independently set to a second different brightness state.

In some embodiments, color images may be displayed in combination with the R.G.B. color filters 223a in the transmissive part 201 in the transmissive or transflective operating modes, while black and white monochromic images may be shown in the reflective part 202 in the reflective operating modes.

### 2.2.1 Stripe-Shaped Pixel Electrode

FIG. 2B illustrates a stripe-shaped pixel electrode, which may be used in both the transmissive and reflective parts of a LCD unit structure 200 of FIG. 2A, in accordance with some embodiments of the present invention. In some possible embodiments, FIG. 2A may be a cross-section of the LCD unit structure 200 along A-A′ in FIG. 2B. In some embodiments, the pixel electrode may be a patterned transparent conductive layer as illustrated and may be formed by the ITO layers 212a and 212b of FIG. 2A.

In some embodiments, on the top surface of the top substrate 224 of FIG. 2A, a top polarizer layer may be laminated, comprising a top HW retarder such as 254 of FIG. 2A and a top linear polarizer such as 226 of FIG. 2A. In some embodiments, on the bottom surface of the bottom substrate 214 of FIG. 2A, a bottom polarizer layer may be attached, comprising a bottom linear polarizer such as 216 of FIG. 2A, a first HW retarder 264 of FIG. 2A, and a second HW retarder 274 of FIG. 2A. In some embodiments, zero, one, two, or more of the top HW retarder, the first HW retarder, and the second HW retarder, may be biaxial.

In an embodiment, parameters for the LC layer 210 of FIG. 2A are: birefringence Δn=0.07 at the wavelength of 550 nm, dielectric anisotropy Δ∈=8.8 and rotational viscosity γ1=0.09 Pa·s. The metallic width of stripe pixel electrode, w, is at 4 um, and the gap between the neighboring stripe pixel electrodes, g, is at 6 um. The LC layer 210 has homogenous alignment in the voltage-off state. The azimuth angle θₕ for the liquid crystal layer, i.e. the liquid crystal alignment direction, is 110°, and its pre-tilt angle is within 1°. The azimuthal angles of the top and bottom linear polarizer 226 and 216 are arranged at 50° and 140°, respectively. The azimuthal angle θₕ for the top HW retarder 254 is 57.5°, and the azimuthal angles for the first and second HW retarders 264 and 274 are 147.5° and 20° respectively. Here, the HW retarders are biaxial ones, which may be either negative type with nx>nz>ny or positive type with nz>nx>ny. In an example, it may be chosen that Nz=0.5, where Nz=(nx−nz)/(nx−ny), where nx, ny and nz are the refractive index along the x, y and z direction. TABLE 2 shows the detailed parameters for the LCD unit structure 200 in the particular embodiment, with an area ratio 30:70 between the transmissive part and the reflective part.

TABLE 2

| Components | | Example value |
|---|---|---|
| Top linear polarizer | absorption axis (°) | 50 |
| Top biaxial HW retarder | Slow axis direction (°) | 57.5 |
| (Nz = 0.5) | phase retardation (nm) | 270 |
| LC layer in transmissive | alignment direction (°) | 110 |
| part | cell gap (μm) | 3.8 |
| LC layer in reflective | alignment direction (°) | 110 |
| part | cell gap (μm) | 1.9 |
| Second Biaxial HW retarder | Slow axis direction (°) | 20 |
| (Nz = 0.5) | phase retardation (nm) | 270 |
| First Biaxial HW retarder | Slow axis direction (°) | 147.5 |
| (Nz = 0.5) | phase retardation (nm) | 270 |
| Bottom linear polarizer | absorption axis (°) | 140 |

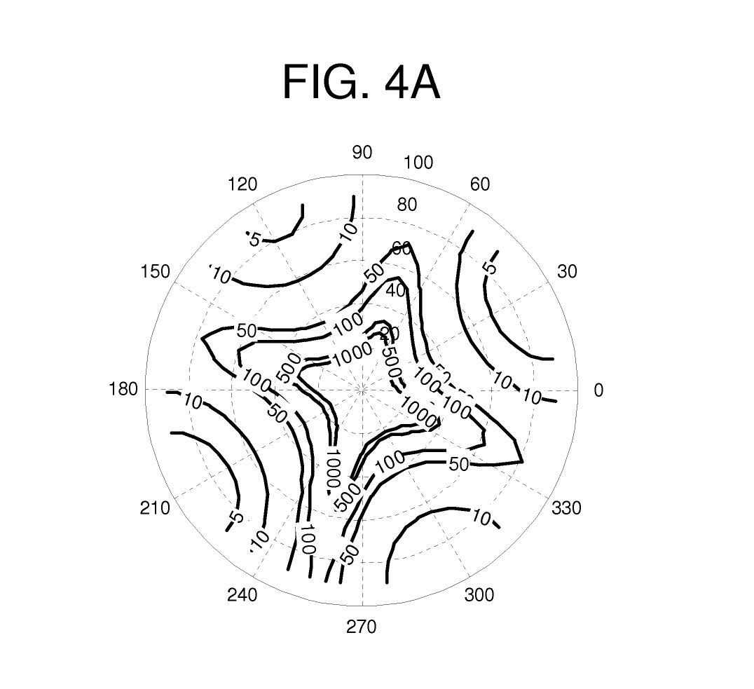

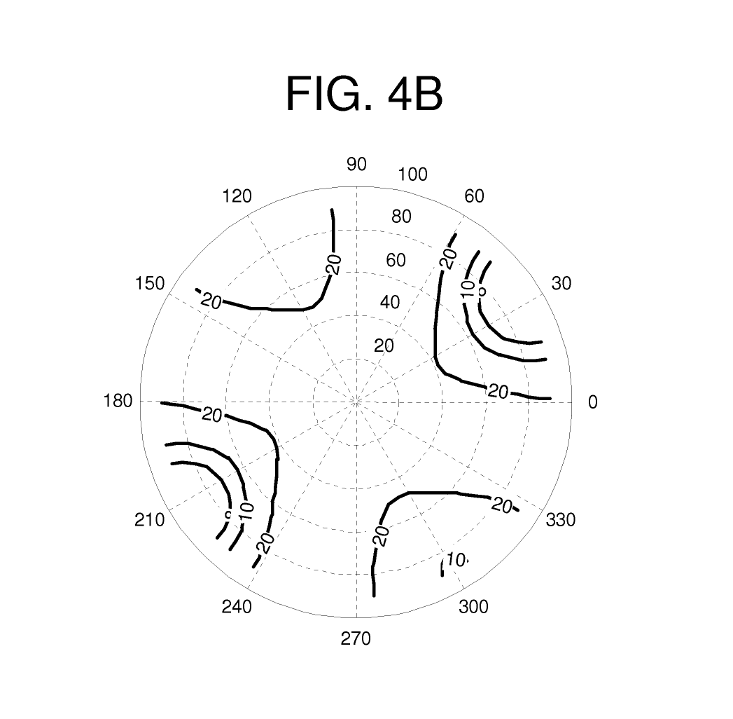

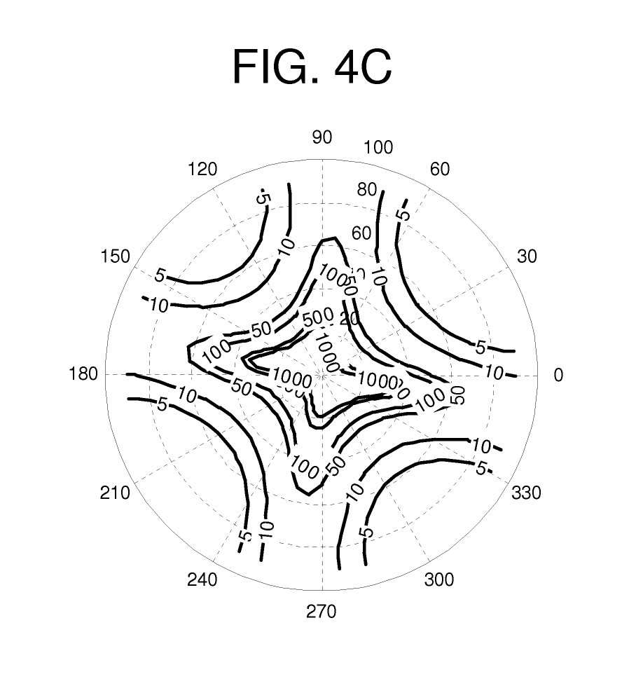

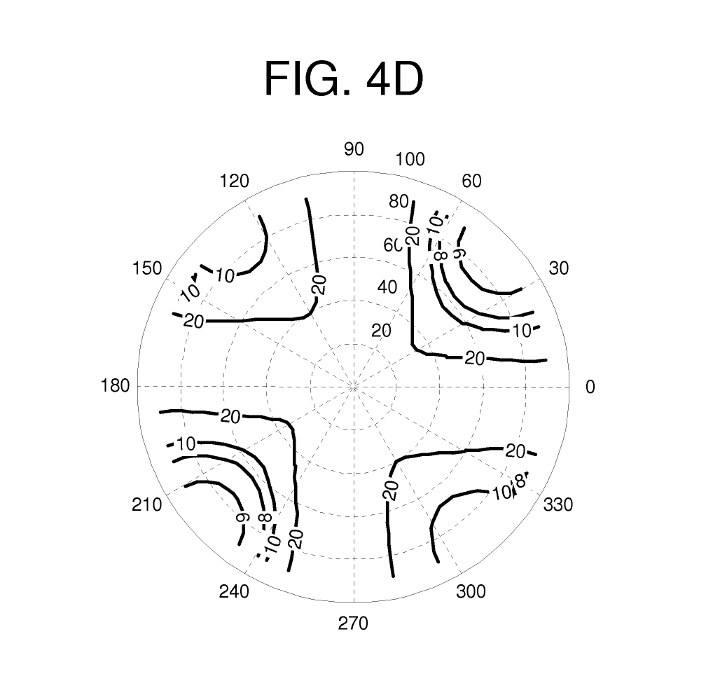

FIG. 4A shows example view angle measurements of a transmissive part of an LCD unit structure such as 200 of FIG. 2A and FIG. 2B, in accordance with some embodiments of the present invention. The applied voltage of 5 Vrms may be applied to between a common electrode and a transmissive electrode. Backlight may white LED light. In some embodiments, the transflective LCD may have a high contrast ratio of above 1000:1 at the normal direction, and maintains a wide view angle on the whole view cone. A contrast ratio of 10:1 may be maintained in an average view cone as wide as ±65°. At the horizontal and vertical directions, a contrast ratio of 10:1 may be maintained in a view cone of ±80°. These wide view angle properties are close to those of transmissive LCDs in an FFS or IPS configuration. Thus, techniques as described herein may be used to make a high definition transflective LCD with a relatively high color content range.

FIG. 4B shows example view angle measurements of a reflective part of an LCD unit structure such as 200 of FIG. 2A and FIG. 2B, in accordance with some embodiments of the present invention. The applied voltage of 5 Vrms may be applied to between a common electrode and a reflective electrode. The LCD unit structure 200 may be under the ambient sunlight, D65, with an incident angle of 45° onto the LCD panel. In some embodiments, the reflective part may be of a wide-band QW circular polarization configuration. In some embodiments, a high contrast ratio of 20:1 may be maintained along the horizontal and vertical directions with a view cone of ±85°. In some embodiments, a wide view angle may be maintained in the whole view cone with a contrast ratio of around 8:1. The high contrast and wide view angle properties in the reflective part provides good outdoor sunlight readability in the electric paper and reader applications, for example, when the transflective LCD operates in the reflective mode.

A light recycling/redirecting film may also be added between the BLU and the bottom polarization layer 216 to recycle backlight from the reflective part 202 into the transmissive part 201, as further explained, resulting in a high optical output efficiency of the BLU in a display using the LCD unit structure 200, even when the areas of the transmissive part 201 and the reflective part 202 are comparable.

### 2.2.2 Zigzag-Shaped Electrode

FIG. 2C illustrates a zigzag-shaped pixel electrode, which may be used in both the transmissive and reflective parts of a LCD unit structure 200 of FIG. 2A, in accordance with some embodiments of the present invention. In some possible embodiments, FIG. 2A may be a cross-section of the LCD unit structure 200 along A-A′ in FIG. 2C. In some embodiments, the pixel electrode may be a patterned transparent conductive layer as illustrated and may be formed by the ITO layers 212a and 212b of FIG. 2A. In various embodiments, a bending angle formed between the LC alignment direction and the conductive segments in the transparent conductive layer as illustrated in FIG. 2C may be 0°, 5°, 10°, 15°, 20°, 25°, or another degree.

In some embodiments, on the top surface of the top substrate 224 of FIG. 2A, a top polarizer layer may be laminated, comprising a top HW retarder such as 254 of FIG. 2A and a top linear polarizer such as 226 of FIG. 2A. In some embodiments, on the bottom surface of the bottom substrate 214 of FIG. 2A, a bottom polarizer layer may be attached, comprising a bottom linear polarizer such as 216 of FIG. 2A, a first HW retarder 264 of FIG. 2A, and a second HW retarder 274 of FIG. 2A. In some embodiments, zero, one, two, or more of the top HW retarder, the first HW retarder, and the second HW retarder, may be biaxial.

In one embodiment, parameters for the LC layer 210 of FIG. 2A are: birefringence Δn=0.07 at the wavelength of 550 nm, dielectric anisotropy Δ∈=8.8 and rotational viscosity γ1=0.09 Pa·s. The zigzag shaped pixel electrode has a bending angle, α, at 30° as shown in FIG. 2C. The metallic width of zigzag pixel electrode, w, is at 6 um, and the gap between the neighboring zigzag pixel electrodes, g, is at 6 um. The LC layer 210 has homogenous alignment in the voltage-off state. The azimuth angle θₕ for the liquid crystal layer, i.e. the liquid crystal alignment direction, is 120°, and its pre-tilt angle is within 1°. The azimuthal angles of the top and bottom linear polarizer 226 and 216 are arranged at 60° and 150°, respectively. The azimuthal angle θₕ for the top HW retarder 254 is 67.5°, and the azimuthal angles for the first and second HW retarders 264 and 274 are 157.5° and 30° respectively. Here, the top and second HW retarders are biaxial ones, which may be either negative type with nx>nz>ny or positive type with nz>nx>ny. In an example, it may be chosen that Nz=0.5, where Nz=(nx−nz)/(nx−ny) and nx, ny and nz are the refractive index along the x, y and z direction. The first HW retarder is uniaxial with Nz=1.0. TABLE 3 shows the detailed parameters for the LCD unit structure 200 in the particular embodiment, with an area ratio 50:50 between the transmissive part and the reflective part.

TABLE 3

| Components | | Example value |
|---|---|---|
| Top linear polarizer | absorption axis (°) | 60 |
| Top biaxial HW retarder | slow axis direction (°) | 67.5 |
| (Nz = 0.5) | Phase retardation (nm) | 270 |
| LC layer in transmissive | alignment direction (°) | 120 |
| part | cell gap (μm) | 3.8 |
| LC layer in reflective | alignment direction (°) | 120 |
| part | cell gap (μm) | 1.9 |
| Second Biaxial HW retarder | slow axis direction (°) | 30 |
| (Nz = 0.5) | Phase retardation (nm) | 270 |
| First Uniaxial HW retarder | slow axis direction (°) | 157.5 |
| (Nz = 1.0) | Phase retardation (nm) | 270 |
| Bottom linear polarizer | absorption axis (°) | 150 |

FIG. 4C shows example view angle measurements of a transmissive part of an LCD unit structure such as 200 of FIG. 2A and FIG. 2C, in accordance with some embodiments of the present invention. The applied voltage of 5 Vrms may be applied to between a common electrode and a transmissive electrode. Backlight may white LED light. In some embodiments, the transflective LCD may have a high contrast ratio of above 1000:1 at the normal direction, and maintains a wide view angle on the whole view cone. A contrast ratio of 10:1 may be maintained in an average view cone as wide as ±65°. At the horizontal and vertical directions, a contrast ratio of 10:1 may be maintained in a view cone of ±85°. These wide view angle properties are close to those of transmissive LCDs in an FFS or IPS configuration. Thus, techniques as described herein may be used to make a high definition transflective LCD with a relatively high color content range.

FIG. 4D shows example view angle measurements of a reflective part of an LCD unit structure such as 200 of FIG. 2A and FIG. 2C, in accordance with some embodiments of the present invention. The applied voltage of 5 Vrms may be applied to between a common electrode and a reflective electrode. The LCD unit structure 200 may be under the ambient sunlight, D65, with an incident angle of 45° onto the LCD panel. In some embodiments, the reflective part may be of a wide-band QW circular polarization configuration. In some embodiments, a high contrast ratio of 20:1 may be maintained along the horizontal and vertical directions with a view cone of ±85°. In some embodiments, a wide view angle may be maintained in the whole view cone with a contrast ratio of around 6:1. The high contrast and wide view angle properties in the reflective part provides good outdoor sunlight readability in the electric paper and reader applications, for example, when the transflective LCD operates in the reflective mode.

A light recycling/redirecting film may also be added between the BLU and the bottom polarization layer 216 to recycle backlight from the reflective part 202 into the transmissive part 201, as further explained, resulting in a high optical output efficiency of the BLU in a display using the LCD unit structure 200, even when the areas of the transmissive part 201 and the reflective part 202 are comparable.

2.3 In-Plane Switching (IPS)

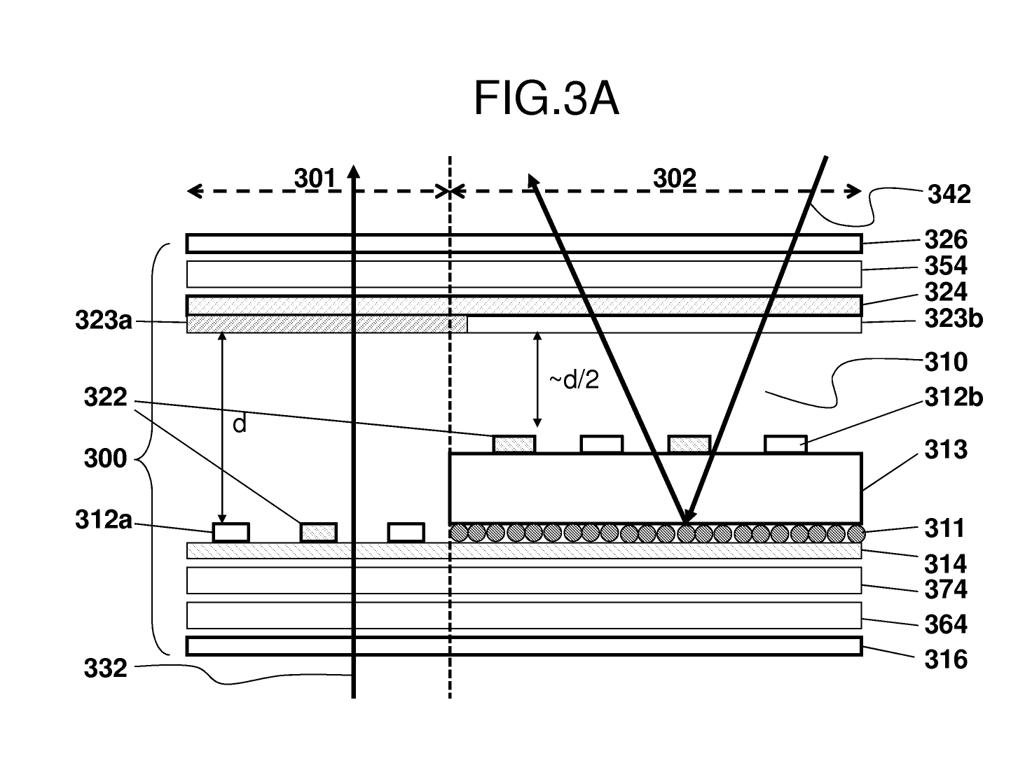

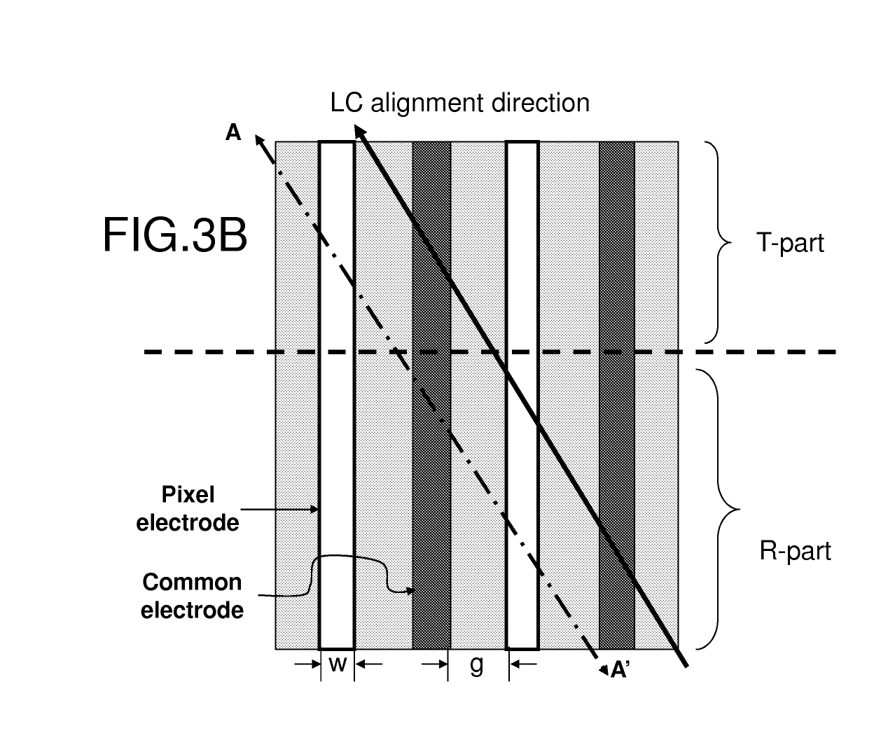

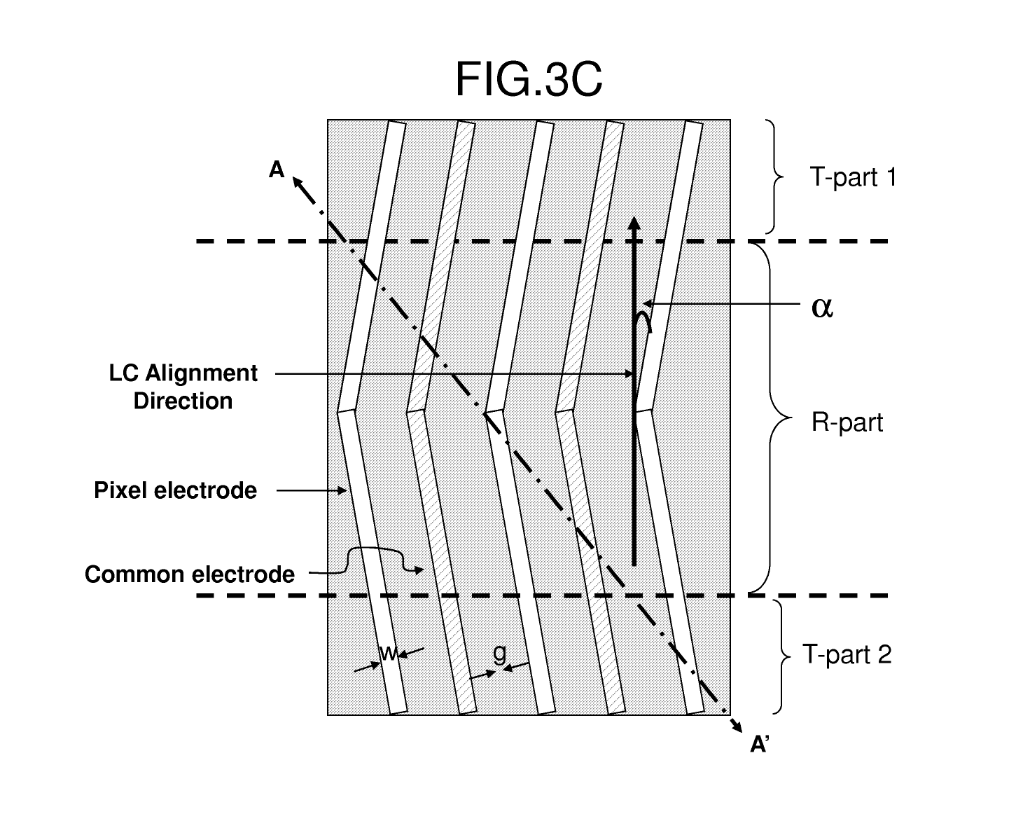

FIG. 3A illustrates a schematic cross-sectional view of an example transflective LCD unit structure 300. As illustrated, the LCD unit structure 300 comprises a transmissive part 301 and a reflective part 302 along the horizontal direction of FIG. 3A. The transmissive part 301 and the reflective part 302 have different layered structures along the vertical direction of FIG. 3A.

In some embodiments, the LCD unit structure 300 comprises a layer 310 of homogeneously aligned liquid crystal material extending over both the transmissive part 301 and the reflective part 302. When both the transmissive part 101 and the reflective part 302 comprise structures to operate in an FFS configuration as illustrated here, the liquid crystal layer 310 in both the transmissive part 301 and the reflective part 302 may align with a same direction in the voltage-off state. The liquid crystal layer 310 may be filled into a cell space by a capillary effect or a one-drop filling process under the vacuum condition. In some embodiments, the liquid crystal layer 310 is of a positive dielectric anisotropy type with Δ∈>0. In some embodiments, the liquid crystal layer 310 is of a negative dielectric anisotropy type with Δ∈<0.

Color filters 323a may be deposited on or near a surface of a top substrate layer 324. The color filters may cover both the transmissive part 301 and some, or all, area of the reflective part 302, or only cover the transmissive part 301, as viewed by a viewer from the top direction of FIG. 3A. In some possible embodiments, there may be red, green and blue (RGB) color filters 323a deposited on or near a surface of the top substrate layer 324, e.g., the inner surface of the top substrate layer 324 facing the liquid crystal layer 310 in the transmissive part 301. In areas that are not covered by the color filters 323a, an over-coating layer 323b may be configured. This over-coating layer 323b may be a passivation layer comprising an organic material such as a-Si:C:O and a-Si:O:F, or an inorganic material such as silicon nitride (SiNx) and silicon oxide (SiO2), prepared by plasma enhanced chemical vapor deposition or other similar sputtering methods.

A top retarder 354, which is equivalent to a half-wave (HW) plate, may be inserted between LC layer 310 and the layer comprising the color filters 323a and/or the over-coating layer 323b. An over-coating layer 313 may be formed in a partially etched region by a photolithographic etching process in the reflective part 302. In various embodiments, the over-coating layer 313 may comprise acrylic resin, polyamide, or novolac epoxy resin.

The transmissive part 301 may have a different liquid crystal cell gap than that of the reflective part 302. In some embodiments, in part due to the over-coating layer 313, the liquid crystal cell gap in the reflective part 302 may be approximately one half of the liquid crystal cell gap in the transmissive part 301.

A patterned ITO layer may be located on or near the inner surface, which faces the liquid crystal layer 310, of a bottom substrate layer 314 and the over-coating layer 313, comprising a transmissive electrode 312a, a reflective electrode 312b, and a common electrode 322. In some embodiments, a metallic reflective layer 311 such as aluminum (Al) or silver (Ag) may be inserted adjacent to the inner face of the bottom substrate layer 314. In some embodiments, this metallic reflective layer 311 may be a bumpy metal layer.

The patterned ITO layer may form a perforated pattern comprising a plurality of regular shapes such as stripes or circles, rectangles, etc. A conductive material is deposited substantially only in the regular shapes of patterns. In some embodiments, these regular shapes of patterns in the ITO layer is electrically insulated or otherwise separated by a gap of a non-conductive material, for example, a dielectric material or simply the liquid crystal material from the layer 310.

A bottom linear polarization layer 316 and a top linear polarization layer 326 with orthogonal polarization axes may be attached on outer surfaces of the bottom substrate layer 314 and top substrate layer 324 respectively.

In some embodiments, the perforated pattern in the ITO layer may comprise three or more separate independent perforated sub-patterns. The three or more separate independent perforated sub-patterns may be used as a transmissive electrode such as 312a for the transmissive part 301, a reflective electrode such as 312b for the reflective part 302, and a common electrode such as 322 for the transmissive and reflective parts 301 and 302. A switching element may be configured in the unit structure 300 to control whether the reflective electrode is connected or disconnected with the transmissive electrode in the transmissive part 301. For example, in some operating modes of a transflective LCD display comprising the LCD unit structure 300, the switching element, working in conjunction with display mode control logic, may cause the reflective electrode to be connected to the transmissive electrode; hence, the reflective and transmissive electrodes may be driven by a same signal to cause the transmissive part 301 and the reflective part 302 to simultaneously express a same pixel or sub-pixel value. In some other operating modes, on the other hand, the switching element may cause the reflective electrode to be disconnected from the transmissive electrode; hence, the reflective and transmissive electrodes may be driven by separate signals to cause the transmissive part 301 and the reflective part 302 to independently express different pixel or sub-pixel values. For example, in a transmissive operating mode, the transmissive part 301 may be set according to a pixel or sub-pixel value based on image data, while the reflective part 302 may be set in a dark black state. In a reflective operating mode, on the other hand, the reflective part 302 may be set according to a pixel or sub-pixel value based on image data, while the transmissive part 301 may be set in a dark black state.

The switching element may be implemented by one or more TFTs hidden beneath the metallic reflective layer 311 in the reflective part 302 to improve the aperture ratio of the transflective LCD.

In some embodiments, in the voltage-off state, the homogeneously aligned liquid crystal layer 310 may be aligned in a direction such that the liquid crystal layer 310 in the transmissive part 301 is substantially a half-wave plate, while the liquid crystal layer 310 in the reflective part 302 is substantially a quarter-wave plate. In different embodiments, liquid crystal materials with different electrically controllable birefringence properties may be used in the liquid crystal layer 310. In some embodiments, rubbed polyimide layers, not shown in FIG. 3A, may be formed near a surface of the liquid crystal layer 310 to induce the liquid crystal layer 310 near the rubbed polyimide layers to be homogeneously aligned along a rubbing direction in parallel with the planar surfaces of the substrate layers 314 and 324.

In some embodiments, in the reflective part 316, the top retarder 354 has an azimuth angle of, for example, θₕ. In the voltage-off state, the liquid crystal layer 310 is a quarter-wave plate with an azimuth angle of, for example, θ_{q}. In some embodiments, the top retarder 354 and the liquid crystal layer 310 may form a wideband quarter-wave plate. Since the optical path of the ambient light 342 crosses the top retarder 354 and the liquid crystal layer 310 twice, the optical configuration of the reflective part 302 effectively comprises two broadband quarter-wave with the same azimuth angles θₕ and θ_{q}. Depending on a choice of an optimized central wavelength in the visible range from 380 nm to 780 nm, a retardation value of the broadband quarter-wave plates may be configured with a value between 160 nm and 400 nm. Further, in some embodiments, to realize a pair of achromatic broadband quarter-wave plates in the reflective part, the azimuth angles θₕ and θ_{q} may be configured to satisfy one of the two expressions (1) and (2) as described above.

In the transmissive part 301, in the voltage-on state, an in-plane switching effect exists between the common electrode and the transmissive electrode, which is a portion of the ITO layer 312a, to twist liquid crystal molecules above the transmissive electrode. In some embodiments, the in-plane switching effect causes the whole or a part of backlight to pass through the top polarization layer 326 towards the viewer, resulting in a bright state.

When the reflective part 302 is in the voltage-on state, an in-plane switching effect exists between the common electrode and the reflective electrode, which is a portion of the ITO layer 312b, to twist liquid crystal molecules above the reflective electrode to cause the liquid crystal layer 310 in the reflective part 301 no longer to be a quarter-wave plate. In some embodiments, the ambient light 342, which is blocked in the voltage-off state, may be reflected off from the metallic reflective layer 311 to show a bright state in the reflective part 302.

The voltage-on state of the transmissive part 301 and the voltage-on state of the reflective part 302 may be independently set. For example, when the switching element causes the reflective electrode to connect to the transmissive electrode, both the transmissive part 301 and the reflective part 302 may be set to a correlated brightness state based on a same pixel value. When the reflective electrode is disconnected to the transmissive electrode, the transmissive part 301 may be set to a first brightness state while the reflective part 302 may be independently set to a second different brightness state.

In some embodiments, color images may be displayed in combination with the R.G.B. color filters 323a in the transmissive part 301 in the transmissive or transflective operating modes, while black and white monochromic images may be shown in the reflective part 302 in the reflective operating modes.

### 2.3.1 Stripe-Shaped Pixel Electrode

FIG. 3B illustrates an alternative stripe-shaped transparent conductive layer, which may be used in both the transmissive and reflective parts of a LCD unit structure 300 of FIG. 3A, in accordance with some embodiments of the present invention. In some possible embodiments, FIG. 3A may be a cross-section of the LCD unit structure 300 along A-A′ in FIG. 3B. In some embodiments, the alternative stripe-shaped transparent conductive layer of FIG. 3B may be formed by an ITO layer that comprises 312a, 312b and 322 in FIG. 3A.

In some embodiments, on the top surface of the top substrate 324 of FIG. 3A, a top polarizer layer may be laminated, comprising a top HW retarder such as 354 of FIG. 3A and a top linear polarizer such as 326 of FIG. 3A. In some embodiments, on the bottom surface of the bottom substrate 314 of FIG. 3A, a bottom polarizer layer may be attached, comprising a bottom linear polarizer such as 316 of FIG. 3A, a first HW retarder 364 of FIG. 3A, and a second HW retarder 374 of FIG. 3A. In some embodiments, zero, one, two, or more of the top HW retarder, the first HW retarder, and the second HW retarder, may be biaxial.

In one embodiment, parameters for the LC layer 310 of FIG. 3A are: birefringence Δn=0.07 at the wavelength of 550 nm, dielectric anisotropy Δ∈=8.8 and rotational viscosity γ1=0.09 Pa·s. The metallic width of stripe pixel/common electrode, w, is at 4 um, and the gap between the neighboring stripe pixel/common electrodes, g, is at 6 um. The LC layer 310 has homogenous alignment in the voltage-off state. The azimuth angle θₕ for the liquid crystal layer, i.e. the liquid crystal alignment direction, is 120°, and its pre-tilt angle is within 1°. The azimuthal angles of the top and bottom linear polarizer 326 and 316 are arranged at 60° and 150°, respectively. The azimuthal angle θₕ for the top HW retarder 354 is 67.5°, and the azimuthal angles for the first and second HW retarders 364 and 374 are 157.5° and 30° respectively. Here, the HW retarders are biaxial ones, which may be either negative type with nx>nz>ny or positive type with nz>nx>ny. In an example, it may be chosen that Nz=0.5, where Nz=(nx−nz)/(nx−ny) and nx, ny and nz are the refractive index along the x, y and z direction. TABLE 4 shows the detailed parameters for the LCD unit structure 300 in the particular embodiment, with an area ratio 30:70 between the transmissive part and the reflective part.

TABLE 4

| Components | | Example value |
|---|---|---|
| Top linear polarizer | absorption axis (°) | 60 |
| Top biaxial HW retarder | slow axis direction (°) | 67.5 |
| (Nz = 0.5) | Phase retardation (nm) | 270 |
| LC layer in transmissive | alignment direction (°) | 120 |
| part | cell gap (μm) | 3.8 |
| LC layer in reflective | alignment direction (°) | 120 |
| part | cell gap (μm) | 1.9 |
| Second Biaxial HW retarder | slow axis direction (°) | 30 |
| (Nz = 0.5) | Phase retardation (nm) | 270 |
| First Biaxial HW retarder | slow axis direction (°) | 157.5 |
| (Nz = 0.5) | Phase retardation (nm) | 270 |
| Bottom linear polarizer | absorption axis (°) | 150 |

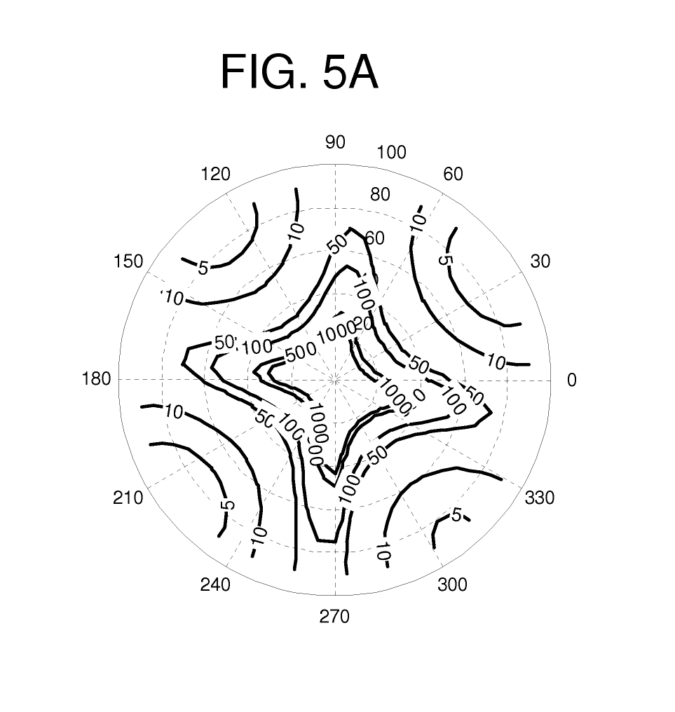

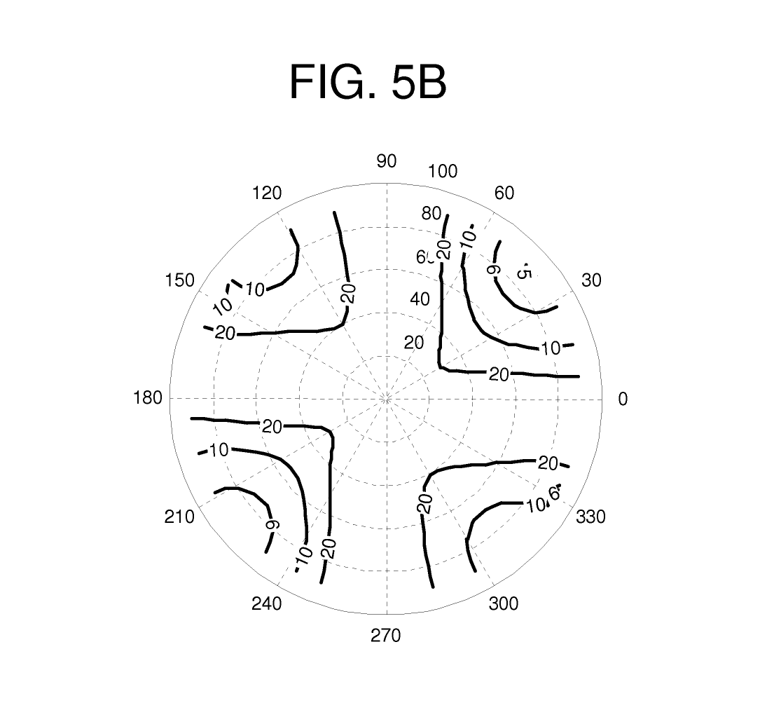

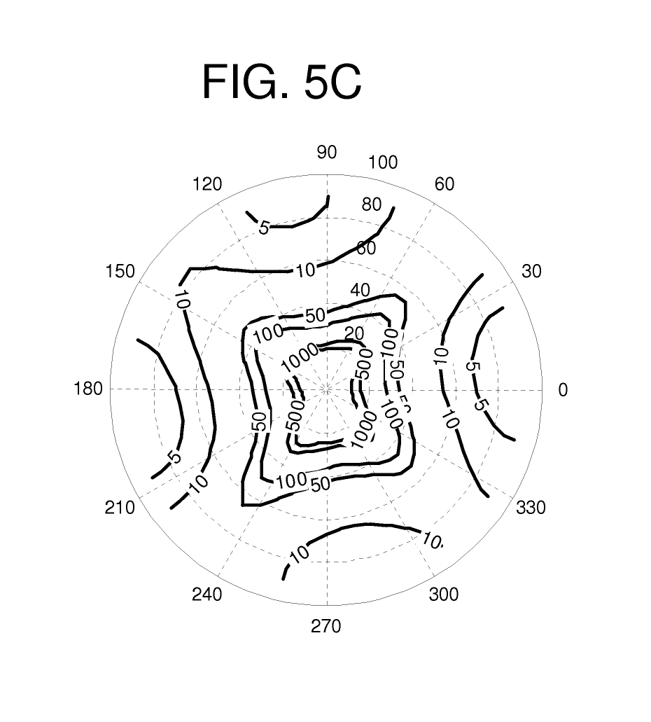

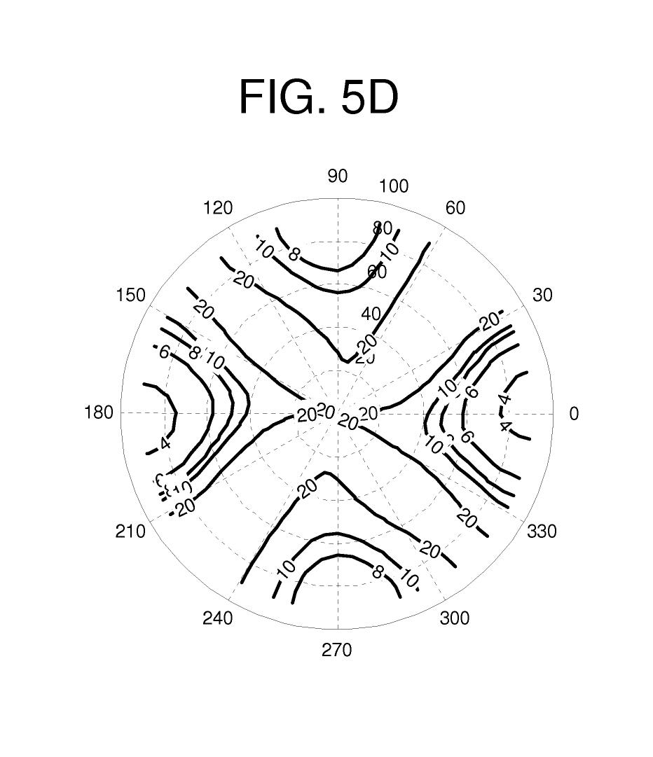

FIG. 5A shows example view angle measurements of a transmissive part of an LCD unit structure such as 300 of FIG. 3A and FIG. 3B, in accordance with some embodiments of the present invention. The applied voltage of 6 Vrms may be applied to between a common electrode and a transmissive electrode. Backlight may white LED light. In some embodiments, the transflective LCD may have a high contrast ratio of above 1000:1 at the normal direction, and maintains a wide view angle on the whole view cone. A contrast ratio of 10:1 may be maintained in an average view cone as wide as ±65°. At the horizontal and vertical directions, a contrast ratio of 10:1 may be maintained in a view cone of ±85°. These wide view angle properties are close to those of transmissive LCDs in an FFS or IPS configuration. Thus, techniques as described herein may be used to make a high definition transflective LCD with a relatively high color content range.

FIG. 5B shows example view angle measurements of a reflective part of an LCD unit structure such as 300 of FIG. 3A and FIG. 3B, in accordance with some embodiments of the present invention. The applied voltage of 6 Vrms may be applied to between a common electrode and a reflective electrode. The LCD unit structure 300 may be under the ambient sunlight, D65, with an incident angle of 45° onto the LCD panel. In some embodiments, the reflective part may be of a wide-band QW circular polarization configuration. In some embodiments, a high contrast ratio of 20:1 may be maintained along the horizontal and vertical directions with a view cone of ±85°. In some embodiments, a wide view angle may be maintained in the whole view cone with a contrast ratio of around 6:1. The high contrast and wide view angle properties in the reflective part provides good outdoor sunlight readability in the electric paper and reader applications, for example, when the transflective LCD operates in the reflective mode.

A light recycling/redirecting film may also be added between the BLU and the bottom polarization layer 316 to recycle backlight from the reflective part 302 into the transmissive part 301, as further explained, resulting in a high optical output efficiency of the BLU in a display using the LCD unit structure 300, even when the areas of the transmissive part 301 and the reflective part 302 are comparable.

### 2.3.2 Zigzag-Shaped Electrode

FIG. 3C illustrates an alternative zigzag-shaped transparent conductive layer, which may be used in both the transmissive and reflective parts of a LCD unit structure 300 of FIG. 3A, in accordance with some embodiments of the present invention. In some possible embodiments, FIG. 3A may be a cross-section of the LCD unit structure 300 along A-A′ in FIG. 3C. In some embodiments, the alternative zigzag-shaped transparent conductive layer of FIG. 3B may be formed by an ITO layer that comprises 312a, 312b and 322 in FIG. 3A. In various embodiments, a bending angle formed between the LC alignment direction and the conductive segments in the transparent conductive layer as illustrated in FIG. 3C may be 0°, 5°, 10°, 15°, 20°, 25°, or another degree.

In some embodiments, on the top surface of the top substrate 324 of FIG. 3A, a top polarizer layer may be laminated, comprising a top HW retarder such as 354 of FIG. 3A and a top linear polarizer such as 326 of FIG. 3A. In some embodiments, on the bottom surface of the bottom substrate 314 of FIG. 3A, a bottom polarizer layer may be attached, comprising a bottom linear polarizer such as 316 of FIG. 3A, a first HW retarder 364 of FIG. 3A, and a second HW retarder 374 of FIG. 3A. In some embodiments, zero, one, two, or more of the top HW retarder, the first HW retarder, and the second HW retarder, may be biaxial.

In one embodiment, parameters for the LC layer 310 of FIG. 3A are: birefringence Δn=0.07 at the wavelength of 550 nm, dielectric anisotropy Δ∈=8.8 and rotational viscosity γ1=0.09 Pa·s. The zigzag shaped common/pixel electrode has a bending angle, α, at 10° as shown in FIG. 3C. The metallic width of zigzag common/pixel electrode, w, is at 4 um, and the gap between the neighboring zigzag common/pixel electrodes, g, is at 8 um. The LC layer 310 has homogenous alignment in the voltage-off state. The azimuth angle θₕ for the liquid crystal layer, i.e. the liquid crystal alignment direction, is 90°, and its pre-tilt angle is within 1°. The azimuthal angles of the top and bottom linear polarizer 326 and 316 are arranged at 30° and 120°, respectively. The azimuthal angle θₕ for the top HW retarder 354 is 37.5°, and the azimuthal angles for the first and second HW retarders 364 and 374 are 127.5° and 0° respectively. Here, the top and second HW retarders are biaxial ones, which may be either negative type with nx>nz>ny or positive type with nz>nx>ny. In an example, it may be chosen that Nz=0.5, where Nz=(nx−nz)/(nx−ny) and nx, ny and nz are the refractive index along the x, y and z direction. The first HW retarder is uniaxial with Nz=1.0. TABLE 5 shows the detailed parameters for the LCD unit structure 300 in the particular embodiment, with an area ratio 40:60 between the transmissive part and the reflective part.

TABLE 5

| Components | | Example value |
|---|---|---|
| Top linear polarizer | absorption axis (°) | 30 |
| Top biaxial HW retarder | slow axis direction (°) | 37.5 |
| (Nz = 0.5) | Phase retardation (nm) | 270 |
| LC layer in transmissive | alignment direction (°) | 90 |
| part | cell gap (μm) | 3.8 |
| LC layer in reflective | alignment direction (°) | 90 |
| part | cell gap (μm) | 1.9 |
| Second Biaxial HW retarder | slow axis direction (°) | 0 |
| (Nz = 0.5) | Phase retardation (nm) | 270 |
| First Uniaxial HW retarder | slow axis direction (°) | 127.5 |
| (Nz = 1.0) | Phase retardation (nm) | 275 |
| Bottom linear polarizer | absorption axis (°) | 120 |

FIG. 5C shows example view angle measurements of a transmissive part of an LCD unit structure such as 300 of FIG. 3A and FIG. 3C, in accordance with some embodiments of the present invention. The applied voltage of 6 Vrms may be applied to between a common electrode and a transmissive electrode. Backlight may white LED light. In some embodiments, the transflective LCD may have a high contrast ratio of above 1000:1 at the normal direction, and maintains a wide view angle on the whole view cone. In some embodiments, the contour bars for the contrast ratio of 10:1 may not be extended into the horizontal and vertical directions that are larger than the view cone of ±80°. In some embodiments, the contrast ratio of 10:1 may be maintained in an average view cone of ±60°. These wide view angle properties are close to those of transmissive LCDs in an FFS or IPS configuration. Thus, techniques as described herein may be used to make a high definition transflective LCD with a relatively high color content range.

FIG. 5D shows example view angle measurements of a reflective part of an LCD unit structure such as 300 of FIG. 3A and FIG. 3C, in accordance with some embodiments of the present invention. The applied voltage of 6 Vrms may be applied to between a common electrode and a reflective electrode. The LCD unit structure 300 may be under the ambient sunlight, D65, with an incident angle of 45° onto the LCD panel. In some embodiments, the reflective part may be of a wide-band QW circular polarization configuration. In some embodiments, a high contrast ratio of 20:1 may be achieved in the normal direction and extended to a view cone of ±20°. In some embodiments, a wide view angle may be maintained on the whole view cone with a contrast ratio of around 4:1. The high contrast and wide view angle properties in the reflective part provides good outdoor sunlight readability in the electric paper and reader applications, for example, when the transflective LCD operates in the reflective mode.

A light recycling/redirecting film may also be added between the BLU and the bottom polarization layer 316 to recycle backlight from the reflective part 302 into the transmissive part 301, as further explained, resulting in a high optical output efficiency of the BLU in a display using the LCD unit structure 300, even when the areas of the transmissive part 301 and the reflective part 302 are comparable.

### 3. Extensions and Variations

To illustrate a clear example, a transmissive part and a reflective part in a transflective LCD unit structure have been described as operating in one of the ECB, FFS, or IPS configurations. In some embodiments, a transflective LCD unit structure may operate in a hybrid mode. In these embodiments, a transmissive part of the transflective LCD unit structure may comprise a transmissive structure as previously described to operate in one of the ECB, FFS, or IPS modes, while a reflective part of the same transflective LCD unit structure may comprise a reflective structure as previously described to operate in a different one of the ECB, FFS, or IPS modes. For example, the transmissive part may have the same structure as that of the transmissive part 201, while the reflective part may have the structure as that of the reflective part 102. Alternatively and/or optionally, the transmissive part may have the same structure as that of the transmissive part 101, while the reflective part may have the structure as that of the reflective part 202. Alternatively and/or optionally, the transmissive part may have the same structure as that of the transmissive part 301, while the reflective part may have the structure as that of the reflective part 102. Other different combinations of a transmissive part and a reflective part in a transflective LCD unit structure may also be used. As noted before, a liquid crystal layer remains homogeneously aligned to a same direction within each of the transmissive part and the reflective part in the voltage-off state. However, the liquid crystal layer portion in the transmissive part may or may not be aligned with the liquid crystal layer portion in the reflective part in the voltage-off state.

LCD unit structures as described herein may be used for expressing different colors. The parameters for an LCD unit structure that is used to express one color may be different from those for another LCD unit structure that is used to express another color, even if both LCD unit structures are part of a same display panel. For example, cell gaps for an LCD unit structure for a “green” color may be different from those for another LCD unit structure for a “red” color, even if both LCD unit structures belong to a same pixel in a same LCD display.

While the preferred embodiments of the invention have been illustrated and described, it will be clear that the invention is not limited to these embodiments only. Numerous modifications, changes, variations, substitutions and equivalents will be apparent to those skilled in the art without departing from the spirit and scope of the invention, as described in the claims.

What is claimed is:

1. A transflective liquid crystal display comprising a plurality of unit structures, each unit structure comprising:
a reflective part, comprising:
first portions of a first polarizing layer, a second polarizing layer, a first substrate layer, a second substrate layer, and a first half-wave retardation film, wherein the second substrate layer is opposite to the first substrate layer; a first common electrode portion; a reflective electrode; an over-coating layer adjacent to one of the first substrate layer and the second substrate layer; a reflective layer adjacent to the first substrate layer;
wherein the first substrate layer and the second substrate layer are between the first polarizing layer and the second polarizing layer;
a first liquid crystal layer portion of a liquid crystal layer between the first substrate layer and the second substrate layer, wherein liquid crystal molecules in the first liquid crystal layer portion are substantially homogeneously aligned along a direction in a voltage-off state;
a transmissive part, comprising:
second portions of the first polarizing layer, the second polarizing layer, the first substrate layer, the second substrate layer, and the first half-wave retardation film;
a second liquid crystal layer portion of the liquid crystal layer between the first substrate layer and the second substrate layer;
a second common electrode portion;
a transmissive electrode;
a second half-wave retardation film;
a third half-wave retardation film;
wherein a cell gap of the first liquid crystal layer portion is different from a cell gap of the second liquid crystal layer portion;
wherein liquid crystal molecules in the second liquid crystal layer portion are substantially homogeneously aligned along a second direction in the voltage-off state.

2. The transflective liquid crystal display according to claim 1, wherein the unit structure further comprises at least one color filter that covers at least an area of the transmissive part, wherein the unit structure is configured to express a color value associated with a color of the at least one color filter.

3. The transflective liquid crystal display according to claim 2, wherein the unit structure is a part of a composite pixel, and wherein the composite pixel comprises another unit structure that is configured to express a different color value other than the color value expressed by the unit structure.

4. The transflective liquid crystal display according to claim 1, wherein a normal direction of a surface of the first substrate layer is aligned in parallel with one or more of the first direction and the second direction.

5. The transflective liquid crystal display according to claim 1, wherein the unit structure further comprises one or more orientation films and wherein one or more of the first direction and the second direction are along a rubbing direction of at least one of the one or more orientation films.

6. The transflective liquid crystal display according to claim 1, wherein at least one of the first half-wave retardation film, the second half-wave retardation film, or the third half-wave retardation film, is one of a uniaxial retardation film, a biaxial retardation film, or an oblique retardation film.

7. The transflective liquid crystal display according to claim 1, wherein the liquid crystal layer comprises a liquid crystal material which optical birefringence is electrically controllable.

8. The transflective liquid crystal display according to claim 1, wherein the first half-wave retardation film and the first liquid crystal layer portion form a wideband quarter-wave plate in the voltage-off state.

9. The transflective liquid crystal display according to claim 1, wherein the first half-wave retardation film has an azimuth angle of θₕ, wherein the first liquid crystal layer portion has an azimuth angle of θ_{q}, and wherein the azimuth angles satisfy one of (1) 60≦4θₕ−2θ_{q}≦120, or (2) −120≦4θₕ−2θ_{q}≦−60.

10. The transflective liquid crystal display according to claim 1, wherein the first half-wave retardation film and the first liquid crystal layer portion in the voltage-off state form a first wideband quarter-wave plate in the reflective part, wherein the second liquid crystal layer portion and the second half-wave retardation film and in the voltage-off state form a second wideband quarter-wave plate in the transmissive part.

11. The transflective liquid crystal display according to claim 10, wherein the first half-wave retardation film has a first azimuth angle of θₕ, wherein the first liquid crystal layer portion has an azimuth angle of θ_{q}, wherein a second azimuth angle of the second half-wave retardation film is substantially θₕ, and wherein θₕ and θ_{q} satisfy one of (1) 60≦4θₕ−2θ_{q}≦120, or (2) −120≦4θₕ−2θ_{q}≦−60.

12. The transflective liquid crystal display according to claim 1, wherein the unit structure comprises a first quarter-wave film, and a second quarter-wave film, wherein the first half-wave retardation film and the first quarter-wave form a first wideband quarter-wave plate in both the transmissive part and the reflective part, and wherein the second half-wave retardation film and the second quarter-wave form a second wideband quarter-wave plate in the transmissive part.

13. The transflective liquid crystal display according to claim 12, wherein the first half-wave retardation film has a first azimuth angle of θₕ, wherein the first quarter-wave film has a second azimuth angle of θ_{q}, wherein a third azimuth angle of the second half-wave retardation film is substantially θₕ, wherein a fourth azimuth angle of the second quarter-wave film is substantially θₕ, and wherein θₕ and θ_{q} satisfy one of (1) 60≦4θₕ−2θ_{q}≦120, or (2) −120≦4θₕ−2θ_{q}≦−60.

14. The transflective liquid crystal display according to claim 1, wherein the unit structure comprises a switching element that is configured to control whether the reflective electrode is electrically connected to the transmissive electrode.

15. The transflective liquid crystal display according to claim 1, wherein the common electrode is located on a first side of the liquid crystal layer and the transmissive electrode and the reflective electrode are located on a second opposing side of the liquid crystal layer.

16. The transflective liquid crystal display according to claim 1, wherein the common electrode, the transmissive electrode, and the reflective electrode are located on a same side of the liquid crystal layer, wherein the unit structure further comprises a passivation layer, wherein the common electrode is located on a first side of the passivation layer, and wherein the transmissive electrode and the reflective electrode are located on a second opposing side of the passivation layer.

17. The transflective liquid crystal display according to claim 1, wherein at least one of the common electrode, the transmissive electrode and the reflective electrode is formed by a non-perforated planar layer of a conductive material.

18. The transflective liquid crystal display according to claim 1, wherein at least one of the common electrode, the transmissive electrode, and the reflective electrode is formed by a plurality of discrete conductive components, and wherein two neighboring discrete conductive components is spatially separated by a non-conductive gap.

19. The transflective liquid crystal display according to claim 1, wherein the unit structure further comprises a light recycling film between the first substrate layer and a backlight unit that redirects backlight from the reflective part to the transmissive part.

20. The transflective liquid crystal display according to claim 19, wherein the light recycling film is configured to turn incident light of any polarized state into redirected light with a particular polarization state.

21. A computer, comprising:
one or more processors;
a transflective liquid crystal display coupled to the one or more processors and comprising a plurality of unit structures, a unit structure comprising:
a reflective part, comprising:
first portions of a first polarizing layer, a second polarizing layer, a first substrate layer, a second substrate layer, and a first half-wave retardation film, wherein the second substrate layer is opposite to the first substrate layer; a first common electrode portion; a reflective electrode; an over-coating layer adjacent to one of the first substrate layer and the second substrate layer; a reflective layer adjacent to the first substrate layer;
wherein the first substrate layer and the second substrate layer are between the first polarizing layer and the second polarizing layer;
a first liquid crystal layer portion of a liquid crystal layer between the first substrate layer and the second substrate layer, wherein liquid crystal molecules in the first liquid crystal layer portion are substantially homogeneously aligned along a direction in a voltage-off state;
a transmissive part, comprising:
second portions of the first polarizing layer, the second polarizing layer, the first substrate layer, the second substrate layer, and the first half-wave retardation film;
a second liquid crystal layer portion of the liquid crystal layer between the first substrate layer and the second substrate layer;
a second common electrode portion;
a transmissive electrode;
a second half-wave retardation film;
a third half-wave retardation film;
wherein a cell gap of the first liquid crystal layer portion is different from a cell gap of the second liquid crystal layer portion;
wherein liquid crystal molecules in the second liquid crystal layer portion are substantially homogeneously aligned along a second direction in the voltage-off state.

22. The computer according to claim 21, wherein the unit structure further comprises at least one color filter that covers at least an area of the transmissive part, wherein the unit structure is configured to express a color value associated with a color of the at least one color filter.

23. The computer according to claim 22, wherein the unit structure is a part of a composite pixel, and wherein the composite pixel comprises another unit structure that is configured to express a different color value other than the color value expressed by the unit structure.

24. The computer according to claim 21, wherein at least one of the first half-wave retardation film, the second half-wave retardation film, or the third half-wave retardation film, is one of a uniaxial retardation film, a biaxial retardation film, or an oblique retardation film.

25. The computer according to claim 21, wherein the liquid crystal layer comprises a liquid crystal material which optical birefringence is electrically controllable.

26. The computer according to claim 21, wherein the first half-wave retardation film and the first liquid crystal layer portion form a wideband quarter-wave plate in the voltage-off state.

27. The computer according to claim 21, wherein the first half-wave retardation film has an azimuth angle of θₕ, wherein the first liquid crystal layer portion has an azimuth angle of θ_{q}, and wherein the azimuth angles satisfy one of (1) 60≦4θₕ−2θ_{q}≦120, or (2) −120≦4θₕ−2θ_{q}≦−60.

28. The computer according to claim 21, wherein the first half-wave retardation film and the first liquid crystal layer portion in the voltage-off state form a first wideband quarter-wave plate in the reflective part, wherein the second liquid crystal layer portion and the second half-wave retardation film and in the voltage-off state form a second wideband quarter-wave plate in the transmissive part.

29. The computer according to claim 21, wherein the unit structure comprises a first quarter-wave film, and a second quarter-wave film, wherein the first half-wave retardation film and the first quarter-wave form a first wideband quarter-wave plate in both the transmissive part and the reflective part, and wherein the second half-wave retardation film and the second quarter-wave form a second wideband quarter-wave plate in the transmissive part.

30. The computer according to claim 21, wherein the unit structure comprises a switching element that is configured to control whether the reflective electrode is electrically connected to the transmissive electrode.

31. The computer according to claim 21, wherein the common electrode is located on a first side of the liquid crystal layer and the transmissive electrode and the reflective electrode are located on a second opposing side of the liquid crystal layer.

32. The computer according to claim 21, wherein the common electrode, the transmissive electrode, and the reflective electrode are located on a same side of the liquid crystal layer, wherein the unit structure further comprises a passivation layer, wherein the common electrode is located on a first side of the passivation layer, and wherein the transmissive electrode and the reflective electrode are located on a second opposing side of the passivation layer.

33. The computer according to claim 21, wherein at least one of the common electrode, the transmissive electrode and the reflective electrode is formed by a non-perforated planar layer of a conductive material.

34. The computer according to claim 21, wherein at least one of the common electrode, the transmissive electrode, and the reflective electrode is formed by a plurality of discrete conductive components, and wherein two neighboring discrete conductive components is spatially separated by a non-conductive gap.

35. The computer according to claim 21, wherein the unit structure further comprises a light recycling film between the first substrate layer and a backlight unit that redirects backlight from the reflective part to the transmissive part.

36. The computer according to claim 35, wherein the light recycling film is configured to turn incident light of any polarized state into redirected light with a particular polarization state.

37. A method of fabricating a transflective liquid crystal display, comprising:
providing a plurality of unit structures, a unit structure comprising:
a reflective part, comprising:
first portions of a first polarizing layer, a second polarizing layer, a first substrate layer, a second substrate layer, and a first half-wave retardation film, wherein the second substrate layer is opposite to the first substrate layer; a first common electrode portion; a reflective electrode; an over-coating layer adjacent to one of the first substrate layer and the second substrate layer; a reflective layer adjacent to the first substrate layer;
wherein the first substrate layer and the second substrate layer are between the first polarizing layer and the second polarizing layer;
a first liquid crystal layer portion of a liquid crystal layer between the first substrate layer and the second substrate layer, wherein liquid crystal molecules in the first liquid crystal layer portion are substantially homogeneously aligned along a direction in a voltage-off state;
a transmissive part, comprising:
second portions of the first polarizing layer, the second polarizing layer, the first substrate layer, the second substrate layer, and the first half-wave retardation film;
a second liquid crystal layer portion of the liquid crystal layer between the first substrate layer and the second substrate layer;
a second common electrode portion;
a transmissive electrode;
a second half-wave retardation film;
a third half-wave retardation film;
wherein a cell gap of the first liquid crystal layer portion is different from a cell gap of the second liquid crystal layer portion;
wherein liquid crystal molecules in the second liquid crystal layer portion are substantially homogeneously aligned along a second direction in the voltage-off state.

38. The method according to claim 37, wherein the unit structure further comprises at least one color filter that covers at least an area of the transmissive part, wherein the unit structure is configured to express a color value associated with a color of the at least one color filter.

39. The method according to claim 37, wherein the liquid crystal layer comprises a liquid crystal material which optical birefringence is electrically controllable.
